(19) United States
(12) Patent Application Publication
(10) Pub. No.: US 2026/0088920 A1
(43) Pub. Date: Mar. 26, 2026

(54) ARTIFICIAL INTELLIGENCE OR MACHINE LEARNING POSITIONING FOR POSITIONING

(71) Applicant: QUALCOMM Incorporated, San Diego, CA (US)

(72) Inventors: Geetha Priya RAJENDRAN, Bangalore (IN); Sven FISCHER, Nuremberg (DE); Prasada Veera Reddy KADIRI, San Diego, CA (US)

(21) Appl. No.: 18/896,166

(22) Filed: Sep. 25, 2024

(51) Int. Cl. H04B 17/391; H04W 64/00

(52) U.S. Cl. CPC H04B 17/3913; H04W 64/006

(57) ABSTRACT

Aspects presented herein may enable a first network entity (e.g., a base station) to request a second network entity (e.g., a location management function (LMF)) to trigger positioning measurements at the first network entity via an access and mobility management function (AMF), an operations, administration, and maintenance (OAM) entity, and/or an external artificial intelligence (AI) or machine learning (ML) (AI/ML) service. In one aspect, a first network entity transmits, to a second network entity, a request for at least one of (1) an initiation of a set of UE positioning related measurements for AI/ML training at the first network entity, or (2) a ground truth label for the AI/ML training at the first network entity. The first network entity receives, based on the request, at least one of: (1) an indication to perform the set of UE positioning related measurements or (2) the ground truth label.

### TECHNICAL FIELD

The present disclosure relates generally to communication systems, and more particularly, to wireless communication involving artificial intelligence (AI) or machine learning (ML) (AI/ML) positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning protocols and techniques that enable mobile network operators to provide high-accuracy location services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus transmits, to a second network entity, a request for at least one of (1) an initiation of a set of user equipment (UE) positioning related measurements for artificial intelligence (AI) or machine learning (ML) (AI/ML) training at the first network entity, or (2) a ground truth label for the AI/ML training at the first network entity. The apparatus receives, based on the request, at least one of: (1) an indication to perform the set of UE positioning related measurements or (2) the ground truth label.

In an aspect of the disclosure, a method, a computer-readable medium, and an apparatus are provided. The apparatus receives a request for at least one of (1) an initiation of a set of UE positioning related measurements for AI/ML training at a first network entity, or (2) a ground truth label for the AI/ML training at the first network entity. The apparatus transmits, to the first network entity based on the request, at least one of: (1) an indication to perform the set of UE positioning related measurements or (2) the ground truth label.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5A is a diagram illustrating an example of direct artificial intelligence (AI)/machine learning (ML) (AI/ML) positioning in accordance with various aspects of the present disclosure.

FIG. 5B is a diagram illustrating an example of AI/ML assisted positioning in accordance with various aspects of the present disclosure.

FIG. 6 is a diagram illustrating an example of different configurations for AI/ML assisted positioning in accordance with various aspects of the present disclosure.

FIG. 7 is a diagram illustrating an example of UE-based positioning with UE-side AI/ML model, direct AI/ML or AI/ML assisted positioning in accordance with various aspects of the present disclosure.

FIG. 8A is a diagram illustrating an example of UE-assisted/location management function (LMF)-based positioning with UE-side AI/ML model, AI/ML assisted positioning in accordance with various aspects of the present disclosure.

FIG. 8B is a diagram illustrating an example of UE-assisted/LMF-based positioning with LMF-side model, direct AI/ML positioning in accordance with various aspects of the present disclosure.

FIG. 9A is a diagram illustrating an example of network node assisted positioning with gNB-side model, AI/ML assisted positioning in accordance with various aspects of the present disclosure.

FIG. 9B is a diagram illustrating an example of network node assisted positioning with LMF-side model, direct AI/ML positioning in accordance with various aspects of the present disclosure.

FIG. 10 is a communication flow illustrating an example procedure of a base station requesting for data collection related to AI/ML operation(s) for positioning in accordance with various aspects of the present disclosure.

FIG. 11 is a communication flow illustrating an example procedure of a base station requesting for data collection related to AI/ML operation(s) for positioning in accordance with various aspects of the present disclosure.

FIG. 12 is a communication flow illustrating an example procedure of a base station requesting for data collection related to AI/ML operation(s) for positioning in accordance with various aspects of the present disclosure.

FIG. 13 is a communication flow illustrating an example procedure of a base station requesting ground truth label and feedback related to AI/ML operation(s) for positioning in accordance with various aspects of the present disclosure.

FIG. 14 is a diagram illustrating an example data monitoring related to AI/ML air interface and AI/ML positioning in accordance with various aspects of the present disclosure.

FIG. 15 is a flowchart of a method of wireless communication.

FIG. 16 is a diagram illustrating an example of a hardware implementation for an example network entity.

FIG. 17 is a flowchart of a method of wireless communication.

FIG. 18 is a diagram illustrating an example of a hardware implementation for an example network entity.

### DETAILED DESCRIPTION

Various aspects relate generally to rules and configurations related to artificial intelligence (AI) or machine learning (ML) (AI/ML) model transferring for user equipments (UEs). In one aspect, for AI/ML training at a base station, the base station may be configured with the capability to request a location management function (LMF) to trigger positioning measurements via an access and mobility management function (AMF) (e.g., using a next generation (NG) interface), and/or the base station may request an operations, administration, and maintenance (OAM) entity or an external AI/ML service to trigger positioning measurements via a gateway mobile location center (GMLC) and the GMLC may forward the data collection request to the AMF. Then, the AMF may forward the request from the base station to the LMF to initiate positioning measurement. In another aspect of the present disclosure, a base station may be configured with the capability to request for data collection for AI/ML training for positioning using an NG application protocol (NGAP) UE identifier (ID) over an NG interface between an AMF and the base station. In another aspect of the present disclosure, an AMF may generate a routing ID for correlate messages over NG and maps an NGAP UE ID and a new radio (NR) positioning protocol A (NRPPa) messages session for data collection to a routing ID. The AMF may also generate a location service (LCS) correlation ID for correlation of messages over an NLI interface and forwards the request to the LMF. The AMF may maintain a mapping of NGAP UE ID, routing ID and LCS correlation identifier. An LMF may use the LCS correlation ID in subsequent NRPPa messages, and an AMF may use the routing ID in the NG NRPPa transport messages. In another aspect of the present disclosure, a base station may transmit a request for ground truth label to an LMF over NRPPa for AI/ML training and validation if the base station does not have the data already via the same routing ID and LCS correlation ID as in the previous NRPPa messages triggered for data collection for AI/ML Training. In response, the LMF may provide the ground truth label to the base station via an NRPPa message using the same routing ID and LCS correlation ID as in the request message. In another aspect of the present disclosure, a base station may be configured to indicate in a measurement report (e.g., an NRPPa measurement report) whether a set of measurements includes actual measurements or AI/ML derived measurements. Then, an LMF may use this information to provide feedback on the desired model. For example, a base station may request for feedback from an LMF on the AI/ML model performance in the base station to improve the accuracy of the AI/ML model. In some examples, the LMF may use existing/default positioning procedures to receive ground truth measurements from other base stations for the same UE to use those measurements.

Particular aspects of the subject matter described in this disclosure can be implemented to realize one or more of the following potential advantages. Aspects presented herein may improve the overall performance and efficiency of AI/ML positioning by enabling a base station to initiate/request various AI/ML positioning related operations. For example, if the LCS client is located in a base station for AI/ML training in the base station, then the base station may be configured to replicate NRPPa messages which may already be supported in an LMF. Additionally, as the LMF may be responsible for providing ground truth label for AI/ML model verification, the LMF may also demand the positioning measurements and the measurements may not terminate in the base station. Hence, it may be simpler or more efficient to leave the LCS client in the LMF, and let the base station requests the LMF to initiate positioning measurements for training in the base station. As such, for AI/ML-related operation(s) at a base station, such as AI/ML training, it may be more suitable to configure the base station with the capability to request an LMF to trigger positioning measurements via an AMF.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

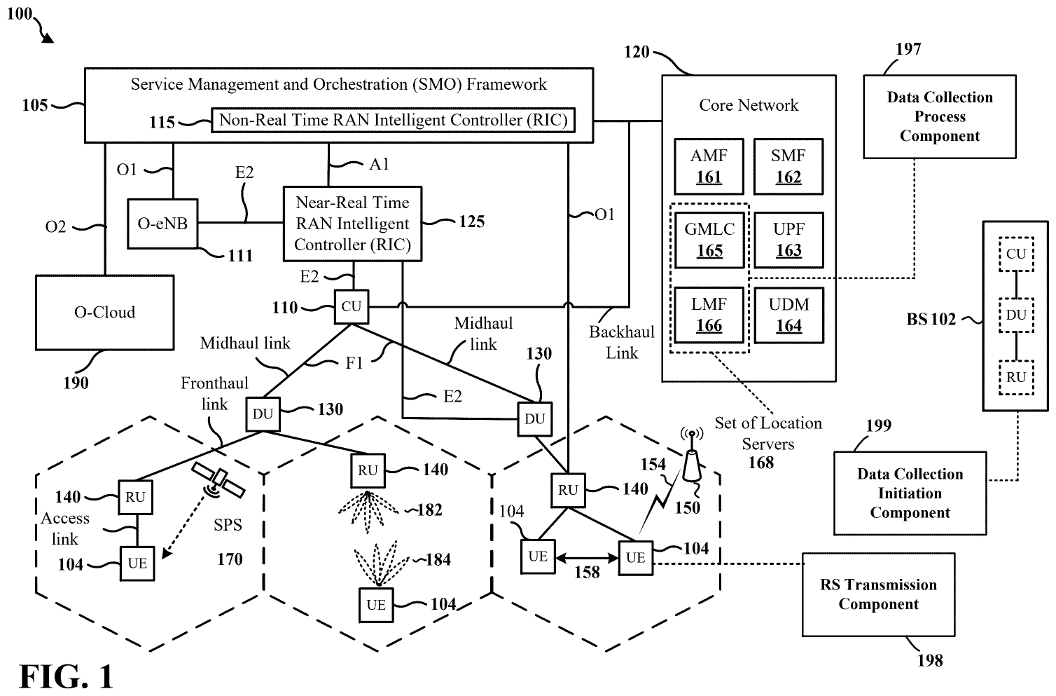

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via dataset collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smartphone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a reference signal (RS) transmission component 198 that may be configured to transmit reference signals to the base station 102. In certain aspects, the base station 102 may have a data collection initiation component 199 that may be configured to transmit, to a second network entity, a request for at least one of (1) an initiation of a set of UE positioning related measurements for artificial intelligence (AI) or machine learning (ML) (AI/ML) training at the first network entity, or (2) a ground truth label for the AI/ML training at the first network entity; and receive, based on the request, at least one of: (1) an indication to perform the set of UE positioning related measurements or (2) the ground truth label. In certain aspects, the one or more location servers 168 may have a data collection process component 197 that may be configured to receive a request for at least one of (1) an initiation of a set of UE positioning related measurements for AI/ML training at a first network entity, or (2) a ground truth label for the AI/ML training at the first network entity; and transmit, to the first network entity based on the request, at least one of: (1) an indication to perform the set of UE positioning related measurements or (2) the ground truth label.

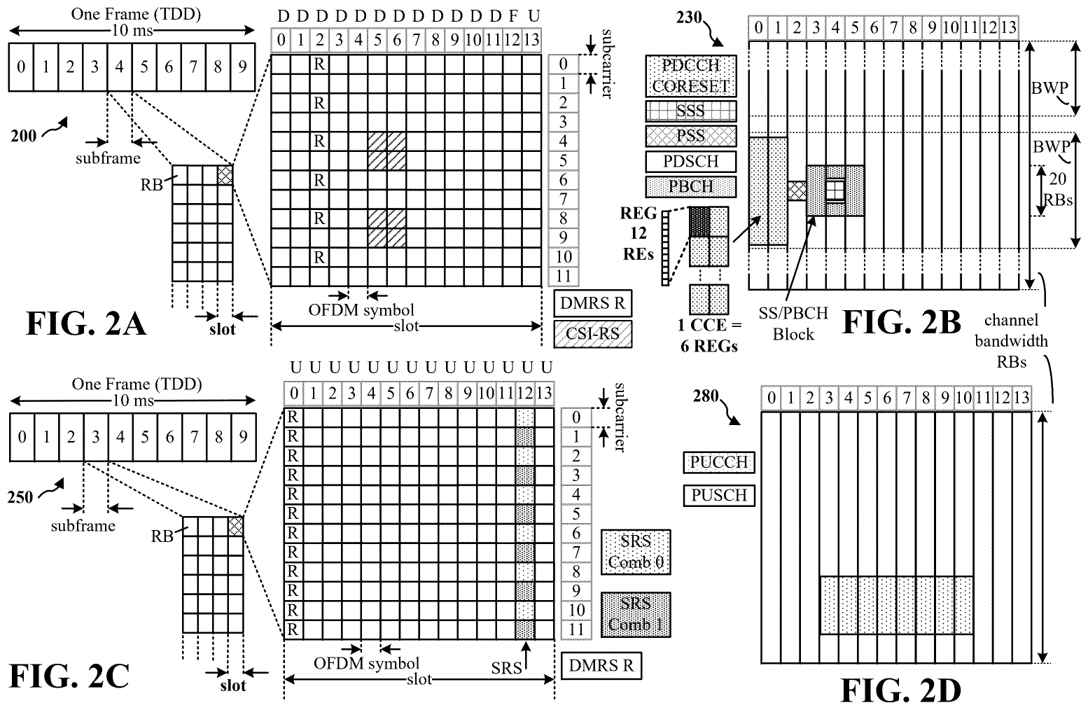

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[KHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

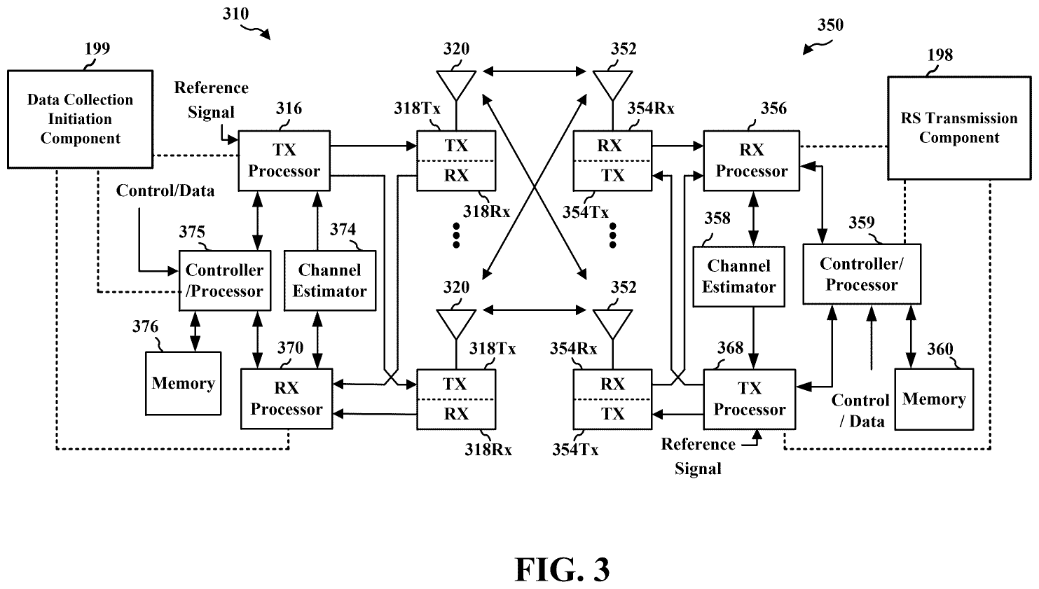

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the RS transmission component 198 of FIG. 1.

At least one of the TX processor 316, the RX processor 370, and the controller/processor 375 may be configured to perform aspects in connection with the data collection initiation component 199 of FIG. 1.

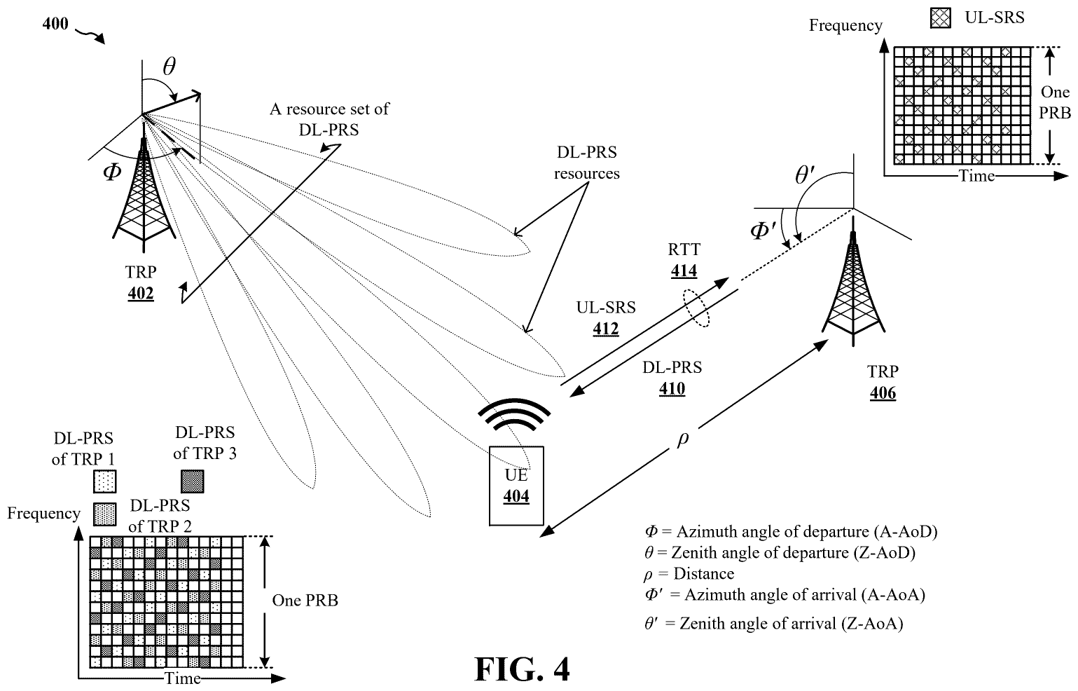

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FRI and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

For purposes of the present disclosure, “UE Rx-Tx time difference” may be defined as T_{UE-RX}−T_{UE-TX}, where: T_{UE-RX} is the UE received timing of downlink subframe #i from a Transmission Point (TP), defined by the first detected path in time. T_{UE-TX} is the UE transmit timing of uplink subframe #j that is closest in time to the subframe #i received from the TP. Multiple DL PRS or CSI-RS for tracking resources, as instructed by higher layers, can be used to determine the start of one subframe of the first arrival path of the TP. For frequency range 1, the reference point for T_{UE-RX} measurement may be the Rx antenna connector of the UE and the reference point for T_{UE-TX} measurement may be the Tx antenna connector of the UE. For frequency range 2, the reference point for T_{UE-RX} measurement may be the Rx antenna of the UE and the reference point for T_{UE-TX} measurement may be the Tx antenna of the UE.

“DL reference signal time difference (DL RSTD)” is the DL relative timing difference between the Transmission Point (TP) j and the reference TP i, defined as T_{SubframeRxj}−T_{SubframeRxi}, where: T_{SubframeRxj} is the time when the UE receives the start of one subframe from TP j. T_{SubframeRxi} is the time when the UE receives the corresponding start of one subframe from TP i that is closest in time to the subframe received from TP j. Multiple DL PRS resources can be used to determine the start of one subframe from a TP. For frequency range 1, the reference point for the DL RSTD may be the antenna connector of the UE. For frequency range 2, the reference point for the DL RSTD may be the antenna of the UE.

“DL PRS reference signal received power (DL PRS-RSRP),” is defined as the linear average over the power contributions (in [W]) of the resource elements that carry DL PRS reference signals configured for RSRP measurements within the considered measurement frequency bandwidth. For frequency range 1, the reference point for the DL PRS-RSRP may be the antenna connector of the UE. For frequency range 2, DL PRS-RSRP may be measured based on the combined signal from antenna elements corresponding to a given receiver branch. For frequency range 1 and 2, if receiver diversity is in use by the UE, the reported DL PRS-RSRP value may not be lower than the corresponding DL PRS-RSRP of any of the individual receiver branches.

“DL PRS reference signal received path power (DL PRS-RSRPP),” is defined as the power of the linear average of the channel response at the i-th path delay of the resource elements that carry DL PRS signal configured for the measurement, where DL PRS-RSRPP for the 1st path delay is the power contribution corresponding to the first detected path in time. For frequency range 1, the reference point for the DL PRS-RSRPP may be the antenna connector of the UE. For frequency range 2, DL PRS-RSRPP may be measured based on the combined signal from antenna elements corresponding to a given receiver branch. For frequency range 1 and 2, if receiver diversity is in use by the UE for DL PRS-RSRPP measurements, the reported DL PRS-RSRPP value included in the higher layer parameter NR-DL-AoD-MeasElement for the first and additional measurements may be provided for the same receiver branch(es) as applied for DL PRS-RSRP measurements

“DL reference signal carrier phase (RSCP)” is defined as the phase of the channel response at the 1^{st} path delay derived from the resource elements carrying DL PRS configured for the measurement. DL RSCP is associated with the center frequency of the DL positioning frequency layer (PFL) configured for the measurement for RRC connected, RRC inactive, and RRC idle modes. For frequency range 1, the reference point for the DL RSCP may be the antenna connector of the UE. For frequency range 2, the reference point for the DL RSCP may be the antenna of the UE.

“DL reference signal carrier phase difference (RSCPD)” is defined as the difference of DL RSCPs measured from DL PRS transmitted in a DL PFL from the transmission point (TP) j and the reference TP i. If UE reports RSCPD measurements together with RSTD measurements in a measurement report element, the reference TP for RSCPD is the same as the reference TP reported for RSTD. For frequency range 1, the reference point for the DL RSCPD may be the antenna connector of the UE. For frequency range 2, the reference point for the DL RSCPD may be the antenna of the UE.

In some implementations, at least one artificial intelligence (AI)/machine learning (ML) (AI/ML) model may be configured/implemented at an entity/node (e.g., a UE, a network entity/node such as a base station, a location server, a location management function (LMF), etc.) for assisting the entity/node with the positioning of a UE. For example, an AI/ML model may be trained to determine the position of a UE based on DL-AoA, DL-TDOA, channel impulse response (CIR), radio frequency (RF) fingerprinting, etc. In most scenarios, using an AI/ML model may significantly improve UE positioning latency, accuracy/reliability, and/or efficiency. For purposes of the present disclosure, an AI/ML model that is implemented at a UE side may be referred to as a “UE-side model” and/or “UE-side AI/ML model.” On the other hand, an AI/ML model that is implemented at a network side may be referred to as a “network-side model,” “network-side AI/ML model,” and/or (network name)-side AI/ML model (e.g., base station-side AI/ML model, LMF-side AI/ML model, etc.).

In addition, positioning that is associated with a UE or a network entity/node using an AI/ML model to determine the position of the UE may be referred to as “direct AI/ML positioning,” whereas positioning that is associated with a UE or a network entity/node performing positioning related measurements using an AI/ML model (and transmitting the positioning related measurements to another entity) to determine the position of the UE may be referred to as “AI/ML assisted positioning” and/or “assisted AI/ML positioning.” Also, UE-based positioning (e.g., UE determines its own position) using at least one UE-side AI/ML model may be referred to as “direct UE AI/ML positioning” and/or “UE direct AI/ML positioning,” whereas UE-assisted positioning (e.g., a UE provides positioning measurements and a network entity, such as an LMF, determines the position for the UE based on the positioning measurements provided by the UE) using at least one UE-side AI/ML model may be referred to as “UE AI/ML assisted positioning,” “UE assisted AI/ML positioning” “AI/ML assisted UE positioning,” and/or “AI/ML UE assisted positioning,” etc. Similarly, network-based positioning (e.g., a network entity, such as an LMF, determines the position for the UE) using at least one network/LMF-side AI/ML model may be referred to as “direct network/LMF AI/ML positioning” and/or “network/LMF direct AI/ML positioning.”

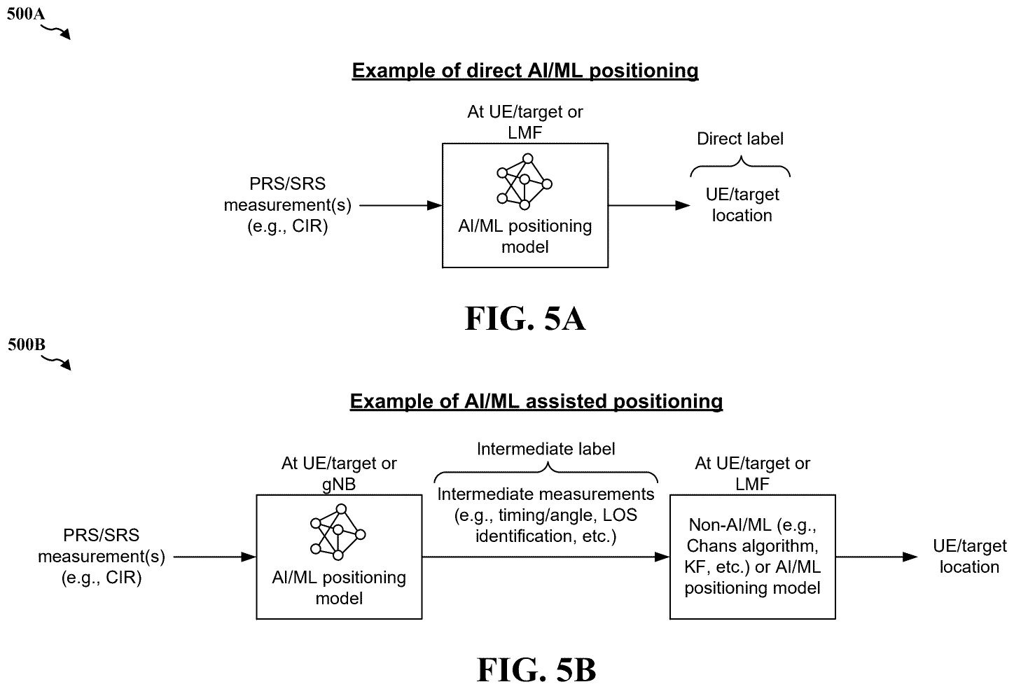

FIG. 5A is a diagram 500A illustrating an example of direct AI/ML positioning in accordance with various aspects of the present disclosure. For direct AI/ML positioning, an entity/node (e.g., a UE, a network entity/node such as a base station, a location server, etc.) may use at least one AI/ML model to determine the position of a UE or a target. For example, a UE may receive and measure PRSs transmitted from one or more base stations, and the UE may determine its position using an AI/ML model based on the PRS measurements. In another example, an LMF may receive PRS measurements from a UE or SRS measurements from a base station, and the LMF may determine the position of the UE using an AI/ML model based on the PRS/SRS measurements.

FIG. 5B is a diagram 500B illustrating an example of AI/ML assisted positioning in accordance with various aspects of the present disclosure. For AI/ML assisted positioning, an entity/node (e.g., a UE, a network entity/node such as a base station, etc.) may use at least one AI/ML model to assist the measurement of reference signals (e.g., positioning reference signals such as PRS, SRS, etc.). Then, the entity/node may transmit the reference signal measurements to a location server, such as an LMF. In response, the location server may determine the position of the UE based on a non-AI/ML mechanism/algorithm, or based on using an AI/ML model to determine the position of the UE. For example, a UE may receive and measure PRSs transmitted from one or more base stations, and the UE may transmit the PRS measurements to an LMF. The PRS measurements may include intermediate measurements, such as timing and/or angle of the PRSs, whether the PRSs are received based on a line-of-sight (LOS) condition or a non-line-of-sight (NLOS) condition, etc. Then, the LMF may determine the position of the UE based on the PRS measurements (e.g., the intermediate measurements) with or without using an AI/ML model. Similarly, a base station may receive and measure SRSs transmitted from a UE, and the base station may transmit the SRS measurements to an LMF. Then, the LMF may determine the position of the UE based on the SRS measurements (e.g., the intermediate measurements) with or without using an AI/ML model.

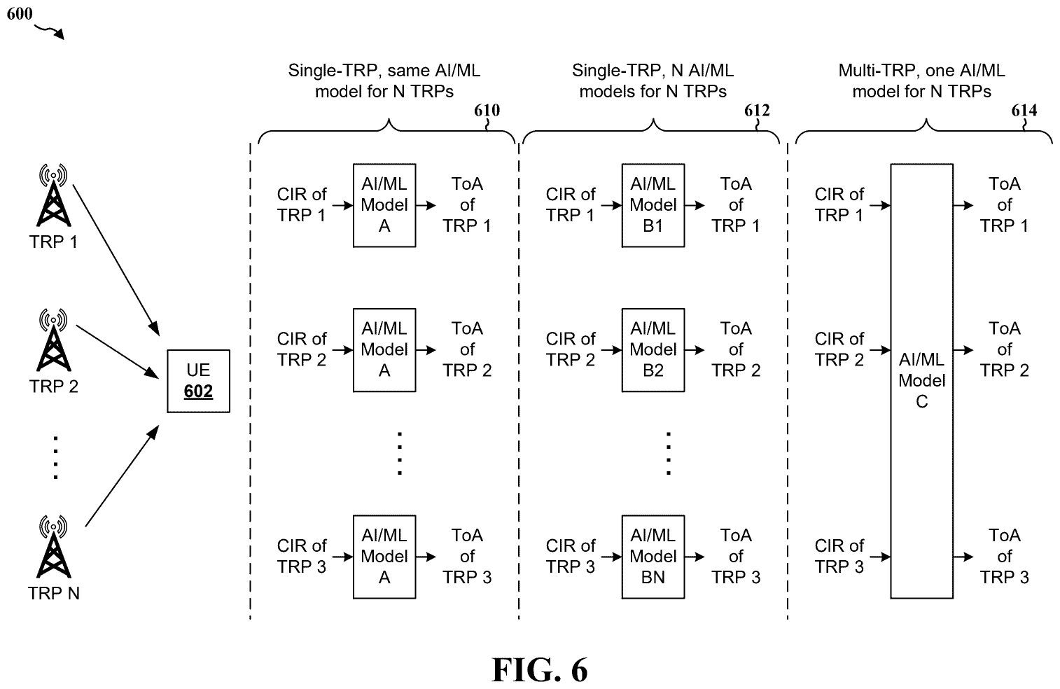

FIG. 6 is a diagram 600 illustrating an example of different configurations for AI/ML assisted positioning in accordance with various aspects of the present disclosure. In one example, as shown at 610, for AI/ML assisted positioning, a same AI/ML model may be used for multiple TRPs, where one AI/ML model may be configured for each TRP (referring to as a “single-TRP” setting). For example, a UE 602 may receive a set of positioning reference signals from N TRPs (e.g., from a first TRP, a second TRP, . . . , and up to an Nth TRP), and measure the channel impulse response (CIR) for the set of positioning reference signals from each TRP. Then, the UE 602 may input the measured CIR for each TRP to an AI/ML model (e.g., AI/ML Model A) configured for/associated with each TRP, where the AI/ML model may infer the time of arrival (ToA) of the positioning reference signal for the corresponding TRP based on the corresponding CIR. In other words, CIR of the first TRP is input to an AI/ML model A associated with the first TRP, CIR of the second TRP is input to an AI/ML model A associated with the second TRP, and CIR of the Nth TRP is input to an AI/ML model A associated with the Nth TRP, etc.

In another example, as shown at 612, different AI/ML models may be used for multiple TRPs, where one AI/ML model may be configured for each TRP (e.g., also the “single-TRP” setting but each TRP may use a different AI/ML model). For example, CIR of the first TRP may be input to a first AI/ML model (e.g., AI/ML Model B₁) for inferring the ToA of the first TRP, CIR of the second TRP may be input to a second AI/ML model (e.g., AI/ML Model B₂ that is different from AI/ML Model B₁) for inferring the ToA of the second TRP, and CIR of the Nth TRP may be input to an Nth AI/ML model (e.g., AI/ML Model Bx that is different from AI/ML Model B₁ and AI/ML Model B₂) for inferring the ToA of the AI/ML Model B₁ TRP, etc.

In another example, as shown at 614, one AI/ML model may be used for multiple TRPs (referring to as a “multi-TRP” setting). For example, CIRs from the N TRPs may be input to one AI/ML model (e.g., AI/ML Model C), and the AI/ML model may infer the ToA for each TRP. For AI/ML assisted positioning, different model input realizations may have different implications on accuracy, generalization, robustness, as well as model complexity and life cycle management (LCM).

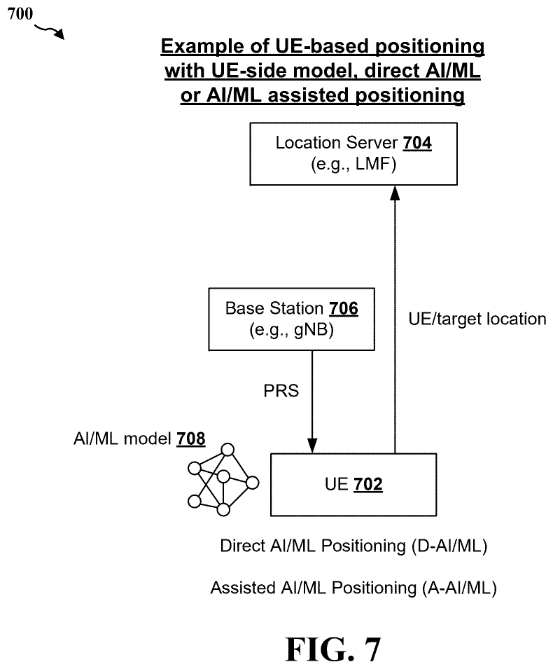

FIG. 7 is a diagram 700 illustrating an example of UE-based positioning with UE-side AI/ML model, direct AI/ML or AI/ML assisted positioning in accordance with various aspects of the present disclosure. In one implementation, a UE 702 may be associated with at least one AI/ML model 708, and the UE 702 may use the at least one AI/ML model 708 to perform the direct AI/ML positioning and/or the assisted AI/ML positioning based on downlink (DL) reference signals, such as positioning reference signals (PRSs). For example, the UE 702 may receive and measure a set of PRSs transmitted from a base station 706, such as measuring the reference signal received power (RSRP), channel impulse response (CIR), DL-AOD, reference signal time difference (RSTD), time of arrival (ToA), and/or time of flight (ToF) of the set of PRSs, etc., which may be collectively be referred to as “PRS measurement(s)” and/or “PRS-based measurement(s).” In some examples, the UE 702 may use the at least one AI/ML model 708 for measuring the set of PRSs (e.g., for assisted AI/ML positioning). In some examples, based on the PRS measurement(s), the UE 702 may use the at least one AI/ML model 708 for determining its position (e.g., for direct AI/ML positioning). Note in this assisted AI/ML positioning example, the UE 702 may use the at least one AI/ML model 708 for performing PRS measurements, and the UE 702 may determine its position based on the PRS measurements without the assistance of an AI/ML model.

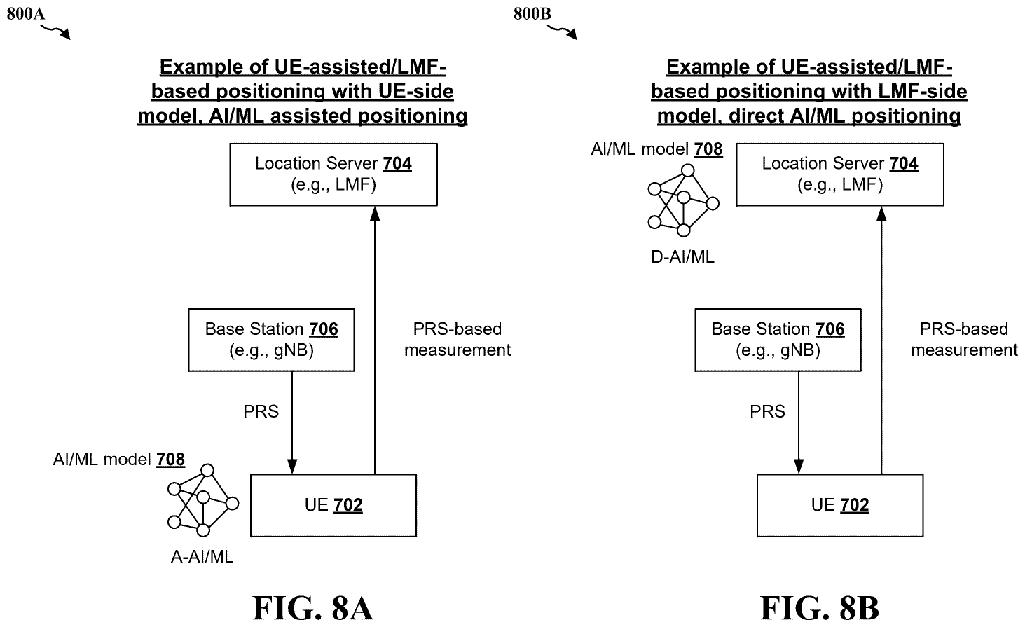

FIG. 8A is a diagram 800A illustrating an example of UE-assisted/LMF-based positioning with UE-side AI/ML model, AI/ML assisted positioning in accordance with various aspects of the present disclosure. In another implementation, a UE 702 may be associated with at least one AI/ML model 708, and the UE 702 may use the at least one AI/ML model 708 to perform or assist measurement(s) of DL reference signals. For example, the UE 702 may receive and measure a set of PRSs transmitted from a base station 706 with the assistance of the at least one AI/ML model 708, which may be referred to as “PRS-based measurement(s).” Then, the UE 702 may transmit the PRS-based measurement(s) to a location server 704, such as an LMF. In response, the location server 704 may determine the position of the UE 702 based on the PRS-based measurement(s) (with or without suing an AI/ML model).

FIG. 8B is a diagram 800B illustrating an example of UE-assisted/LMF-based positioning with LMF-side AI/ML model, direct AI/ML positioning in accordance with various aspects of the present disclosure. In another implementation, a UE 702 may not include a UE-side AI/ML model, and a location server 704 may use at least one AI/ML model 708 to determine the position of the UE 702. For example, the UE 702 may receive and measure a set of PRSs transmitted from a base station 706, and the UE 702 may transmit the PRS-based measurement(s) to the location server 704, such as an LMF. In response, the location server 704 may use the at least one AI/ML model 708 to determine the position of the UE 702 based on the PRS-based measurement(s) from the UE 702.

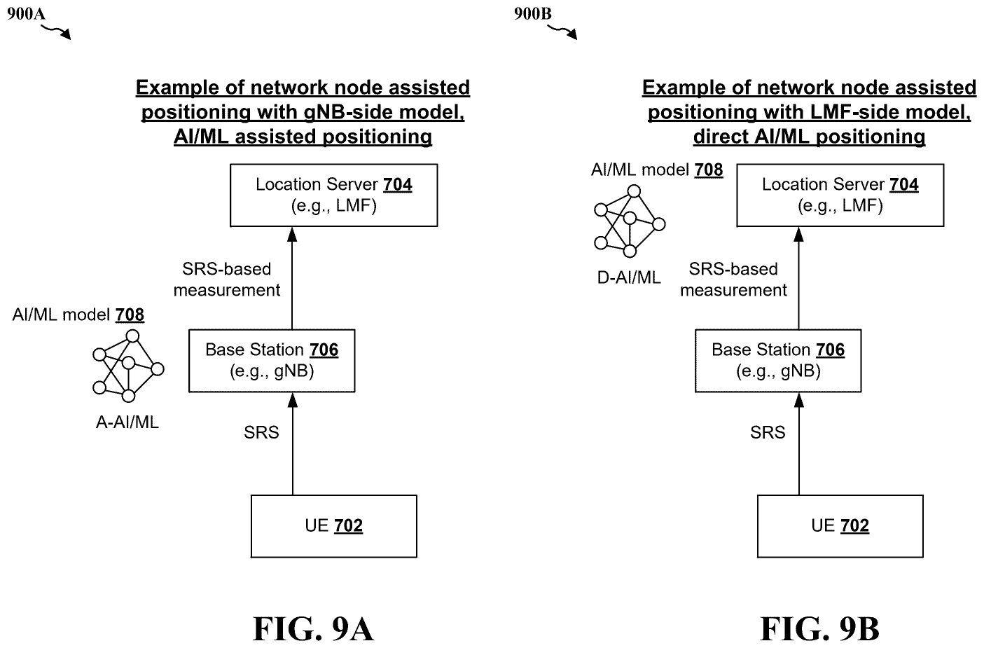

FIG. 9A is a diagram 900A illustrating an example of network (e.g., NG-RAN) node assisted positioning with gNB-side AI/ML model, AI/ML assisted positioning in accordance with various aspects of the present disclosure. In another implementation, a network node, such as a base station 706, may be associated with at least one AI/ML model 708, and the base station 706 may use the at least one AI/ML model 708 to assist measurement(s) of uplink (UL) reference signals, such as sounding reference signals (SRSs). For example, the UE 702 may transmit a set of SRSs to the base station 706, and the base station 706 may receive and measure the set of SRSs (which may be referred to as “SRS-based measurement(s)”) with the assistance of the at least one AI/ML model 708. Then, the base station 706 may transmit the SRS-based measurement(s) to the location server 704, such as an LMF. In response, the location server 704 may determine the position of the UE 702 based on the SRS-based measurement(s) from the base station 706 (with or without suing an AI/ML model).

FIG. 9B is a diagram 900B illustrating an example of network (e.g., NG-RAN) node assisted positioning with LMF-side AI/ML model, direct AI/ML positioning in accordance with various aspects of the present disclosure. In another implementation, a network node, such as a base station 706, may not include an AI/ML model, and a location server 704 may use at least one AI/ML model 708 to determine the position of a UE 702. For example, the UE 702 may transmit a set of SRSs to the base station 706, and the base station 706 may receive and measure the set of SRSs. Then, the base station 706 may transmit the SRS-based measurement(s) to the location server 704, such as an LMF. Based on the SRS-based measurement(s) from the base station 706, the location server 704 may use the at least one AI/ML model 708 to determine the position of the UE 702. For purposes of the present disclosure, positioning described in connection with FIGS. 7, 8A, and 8B may be referred to as AI/ML positioning based on DL reference signals, and positioning described in connection with FIGS. 9A and 9B may be referred to as AI/ML positioning based on UL reference signals.

Table 2 below provides an example list of positioning methods that may be supported by a UE and/or a network entity.

TABLE 2
Example of supported UE positioning methods

| | | UE- | |
|---|---|---|---|
| | UE- | assisted, | NG-RAN |
| Method | based | LMF-based | node assisted |
| A-GNSS (Assisted-Global | Yes | Yes | No |
| Navigation Satellite System) | | | |
| OTDOA (Observed Time | No | Yes | No |
| Difference of Arrival) | | | |
| E-CID (Enhanced Cell ID) | No | Yes | Yes |
| Sensor | Yes | Yes | No |
| WLAN (Wireless Local-Area | Yes | Yes | No |
| Network) | | | |
| Bluetooth | Yes | Yes | No |
| TBS (Terrestrial Beacon System) | Yes | Yes | No |
| DL-TDOA (Downlink-Time | Yes | Yes | No |
| Difference of Arrival) | | | |
| DL-AoD (Downlink-Angle of | Yes | Yes | No |
| Departure) | | | |
| Multi-RTT (Multi-Roundtrip Time) | No | Yes | Yes |
| NR E-CID | No | Yes | Yes |
| UL-TDOA (Uplink-Time Difference | No | No | Yes |
| of Arrival) | | | |
| UL-AoA (Uplink-Angle of Arrival) | No | No | Yes |

In some implementations, for direct AI/ML positioning as described in connection with FIGS. 8B and 9B, type(s) of measurement(s) that may be used as (suitable/potential) input for AI/ML model inference considering performance impact and associated signaling overhead may include channel impulse response (CIR), power delay profile (PDP), reference signal receive power (RSRP), reference signal received path power (RSRPP), and/or reference signal time difference (RSTD), etc. For AI/ML assisted positioning with UE-assisted and network node-assisted positioning described in connection with FIGS. 8A and 9A, respectively, measurement report to carry AI/ML model (suitable/potential) output to a location server such as an LMF may include ToA, path phase, RSTD, line-of-sight (LOS)/non-line-of-sight (NLOS) indicator, RSRPP, and/or soft information/high resolution of RSTD, etc. In some examples, AI/ML model inference output that may provide performance benefits may include timing estimation (note the report to LMF may be derived based on and maybe different from the model inference output) and/or LOS/NLOS indicator.

AI/ML based positioning has been shown to significantly improve the positioning accuracy compared to existing RAT-dependent positioning methods (e.g., network-based positioning discussed in connection with FIG. 4). For example, AI/ML may enhance positioning accuracy from greater than fifteen (15) meters to less than one (1) meter under a heavy non-line-of-sight (NLOS) condition. As such, further improvements and various generalization on AI/ML for positioning have been investigated, which include training and testing on different drops, different clutter parameters, different indoor factory (InF) scenarios, network synchronization error, UE/gNB reception (RX) and transmission (TX) timing error, SNR mismatch, channel estimation error, time varying changes, etc. In some examples, mixed dataset training, fine-tuning/retraining, and model switching may be solutions to scale the generalization. Optimizations for AI/ML model input and trade-offs between signaling overhead and achieved accuracy for AI/ML models have also been evaluated and investigated, which include measurement types (e.g., channel impulse response (CIR), power delay profile (PDP), delay profile (DP)), measurement truncation and subsampling, and/or TRP (anchor) selection and numbers. Different model outputs options have also been evaluated, which include LOS indicator and timing info (e.g., ToA/RSTD) expressed in soft and/or hard values. Impact of non-ideal labeling during training is also investigated, which include label error and label-free scenarios. This may demonstrate feasibility to train with tolerable labeling error and enhancement using semi-supervised training with mixture of label and label-free data. There have also been preliminary investigations for model monitoring using ground truth based and ground truth free approaches (showed preliminary feasibility).

In some examples, data collection for AI/ML positioning may specify one or more of the followings:
(1) ground-truth label (e.g., report from a label data generation entity);
(2) measurement (corresponding to model input) (e.g., report from a measurement data generation entity);
(3) quality indicator (e.g., for and/or associated with ground-truth label and/or measurement, which may be reported from the label and/or the measurement data generation entity and/or as request from a different (e.g., data collection, etc.) entity, etc.); and/or
(4) reference signal (RS) configuration(s) (e.g., at least for deriving measurement, which may be requested from a data generation entity (e.g., a UE, a positioning reference unit (PRU), a transmission reception point (TRP), etc.) to a location management function (LMF) and/or as LMF assistance signaling to the UE/PRU/TRP);
(5) time stamp (e.g., at least for and/or associated with collected data, where there may be separate time stamp for measurement and ground-truth label, such when measurement and ground-truth label are generated by different entities, and may be reported from a data generation entity together with collected data and/or as LMF assistance signaling).

For network node assisted positioning with a base station (gNB)-side AI/ML model as discussed in connection with FIG. 9A, few problems may currently exist. For example, if the location of a UE is specified to be available at a base station (e.g., a gNB) for AI/ML training in the base station for positioning, as the base station is typically not configured to be a location service (LCS) client, the base station may not be able to trigger SRS measurements from a UE. On the other hand, if the base station is configured to be an LCS client (e.g., for purposes of triggering the SRS measurements from a UE), there may be a significant change/impact to an existing network structure. In another example, currently an LMF may initiate location services upon triggers from other services via an access and mobility management function (AMF). When the AMF triggers the location services, the AMF may be configured to create a routing identifier/identification (ID) to route the measurement request from the LMF to a particular UE via a base station. This routing ID may be correlated with an LCS correlation ID in the LMF to identify measurements from a base station and a UE for a particular positioning session. However, if a base station is capable of initiating the SRS measurements for AI/ML training, how routing ID and LCS ID correlation may happen in the AMF to associate the positioning measurement to the corresponding UE may be undefined. In another example, if an LMF is configured to provide ground truth label, currently there may be no available signaling (e.g., new radio (NR) positioning protocol A (NRPPa) messages) for a base station to request for the ground truth label from the LMF. For purposes of the present disclosure, a “ground truth label” may refer to a location of a UE that is derived/estimated at a network entity such as an LMF and/or a true UE position obtained based on (or derived from) a set of sounding reference signal (SRSs) measurements. In another example, currently an entity providing measurements to an LMF and/or a base station may not indicate whether the measurements are for training or the actual measurements, which may impact the overall performance of AI/ML positioning. In another example, if an LMF is configured to perform monitoring of the positioning model, then the LMF may specify the capability to provide feedback on the model performance to a base station, which may not be available currently.

Aspects presented herein may improve the overall performance and efficiency of AI/ML positioning by enabling a base station to initiate/request various AI/ML positioning related operations. For example, in one aspect of the present disclosure, for AI/ML training at a base station, the base station may be configured with the capability to request an LMF to trigger positioning measurements via an AMF (e.g., using a next generation (NG) interface), and/or the base station may request an operations, administration, and maintenance (OAM) entity or an external AI/ML service to trigger positioning measurements via a gateway mobile location center (GMLC) and the GMLC may forward the data collection request to the AMF. Then, the AMF may forward the request from the base station to the LMF to initiate positioning measurement.

In another aspect of the present disclosure, a base station may be configured with the capability to request for data collection for AI/ML training for positioning using an NG application protocol (NGAP) UE identifier (ID) over an NG interface between an AMF and the base station.

In another aspect of the present disclosure, an AMF may generate a routing ID for correlate messages over NG and maps an NGAP UE ID and an NRPPa session for data collection to a routing ID. The AMF may also generate an LCS correlation ID for correlation of messages over an NLI interface and forwards the request to the LMF. The AMF may maintain a mapping of NGAP UE ID, routing ID and LCS correlation identifier. An LMF may use the LCS correlation ID in subsequent NRPPa messages, and an AMF may use the routing ID in the NG NRPPa transport messages.

In another aspect of the present disclosure, a base station may transmit a request for ground truth label to an LMF over NRPPa for AI/ML training and validation if the base station does not have the data already via the same routing ID and LCS correlation ID as in the previous NRPPa messages triggered for data collection for AI/ML Training. In response, the LMF may provide the ground truth label to the base station via an NRPPa message using the same routing ID and LCS correlation ID as in the request message.

In another aspect of the present disclosure, a base station may be configured to indicate in a measurement report (e.g., an NRPPa measurement report) whether a set of measurements includes actual measurements or AI/ML derived measurements. Then, an LMF may use this information to provide feedback on the desired model. For example, a base station may request for feedback from an LMF on the AI/ML model performance in the base station to improve the accuracy of the AI/ML model. In some examples, the LMF may use existing/default positioning procedures to receive ground truth measurements from other base stations for the same UE to use those measurements.

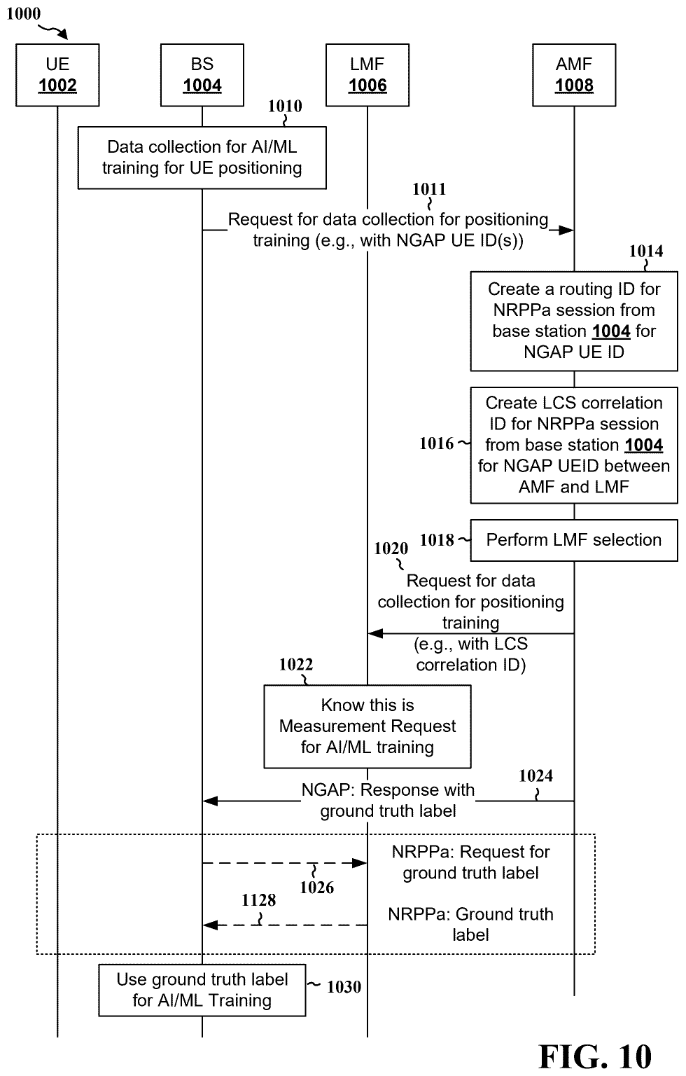

FIG. 10 is a communication flow 1000 illustrating an example procedure of a base station requesting for data collection related to AI/ML operation(s) for positioning in accordance with various aspects of the present disclosure. The numberings associated with the communication flow 1000 do not specify a particular temporal order and are merely used as references for the communication flow 1000.

As discussed above, if the LCS client is located in a base station for AI/ML training in the base station, then the base station may be configured/specified to replicate NRPPa messages which may already be supported in an LMF. Additionally, as the LMF may be responsible for providing ground truth label for AI/ML model verification, the LMF may also demand the positioning measurements and the measurements may not terminate in the base station. Hence, it may be simpler or more efficient to leave the LCS client in the LMF, and let the base station requests the LMF to initiate positioning measurements for training in the base station. As such, in one aspect of the present disclosure, for AI/ML-related operation(s) at a base station, such as AI/ML training, the base station may be configured with the capability to request an LMF to trigger positioning measurements, where the request may be transmitted to the LMF via an AMF (e.g., using a next generation (NG) interface). For purposes of the present disclosure, data collection may refer to collecting data for AI/ML model(s), such as for training, retraining, monitoring, and/or fine-tuning the AI/ML model(s). Data collected for AI/ML may include reference signal (RS) measurements. For example, data collection at a base station may include the base station measuring a set of reference signals (e.g., a set of SRSs) transmitted from one or more UEs, and/or receiving measurements from other entities (e.g., from other base station(s), the one or more UEs, etc.).

In one example, a base station 1004 (e.g., the base station 706, which may also be referred to as a network entity depending on the context) may be associated with at least one AI/ML model that may be used for UE positioning (e.g., for determining the location of UE(s)). For example, the base station 1004 may use the at least one AI/ML model to assist measurements of SRSs transmitted from a UE 1002, such as described in connection with FIG. 9A (referring to as “SRS measurements” hereafter). Then, the base station 1004 may transmit the SRS measurements to an LMF 1006, and the LMF 1006 may determine the position of the UE 1002 based on the SRS measurements.

At 1010, if the base station 1004 specifies/demands data (e.g., SRS measurements) for training the at least one AI/ML model for UE positioning, as shown at 1011, the base station 1004 may be configured to transmit, to an AMF 1008, a request for data collection related to UE positioning/AI/ML training. The request may also be referred to as a request to initiate SRS measurements (e.g., for measuring SRS transmitted from the UE 1002). Depending on implementations, the request may include one or more of: (1) a set of NGAP UE IDs (e.g., an identifier that is used to identify the UE 1002 or a set of identifiers that is used to identify a set of UEs in the AMF 1008 on an N2 reference point), (2) a request for ground truth label, (3) a request for feedback (e.g., for the at least one AI/ML model), (4) a duration related to the data collection (e.g., a duration for the base station 1004 to collect data), (5) a request/indication for measurement type (e.g., AoA, TDoA, etc.), and/or (6) SRS characteristics related to AI/ML model(s) being trained (e.g., SRS characteristics may include transmission comb(s), a start position, a number of symbols, a frequency domain shift, a cell-specific SRS bandwidth configuration parameter C-SRS, resource type positioning, etc.). In some examples, for network-side (e.g., gNB-/LMF-side) model training (e.g., as discussed in connection with FIGS. 8B, 9A, and 9B), the requested SRS characteristics (or requested SRS transmission characteristics) may specify/demand some enhancements to allow/enable an LMF (the LMF 1006) to request a more detailed SRS configuration specified (may be similar to a validity area specific SRS information).

In some scenarios, a discrepancy between AI/ML training and inference may occur for example due to: changes in network synchronization (e.g., system frame number (SFN) initialization time), changes to base station/gNB timing error (e.g., timing error groups (TEGs)), changes to TRP or antenna reference point (ARP) locations and antenna orientation, changes to TRP Rx beams, and/or changes to TRP Rx ARP-IDs for SRS measurements, etc. However, the network conditions may be available in an NG-RAN (e.g., for the network node assisted positioning with gNB-side model as shown by FIG. 9A) or may be provided to an LMF via positioning information exchange (e.g., for the network node assisted positioning with LMF-side model as shown by FIG. 9B). The above and other additional parameter for the positioning information exchange may be added. Thus, for network-side AI/ML model (e.g., as discussed in connection with FIGS. 9A and 9B), a set of network-side (additional) conditions that may affect the training and inference consistency may already be available at a base station/gNB (e.g., the base station 1004) and an LMF (e.g., the LMF 1006) (via existing signalling), and additional parameter (if specified) may be added to a TRP information exchange procedure. Enhancements may be also be specified to particular messages (e.g., additional parameter to request AI/ML enhanced measurements, etc.).

In some scenarios, UE identification (e.g., the identification of the UE 1002) may be specified across the base station 1004, the AMF 1008, and the LMF 1006 to initiate measurements and to correlate the reports. When the base station 1004 requests for measurement for AI/ML training, the base station 1004 may identify the UE 1002 just using the identifier associated with the NG interface. Thus, there may be no common UE identifier between the base station 1004 and the LMF 1006 to identify a particular UE (e.g., the UE 1002) and hence the base station may not create a routing ID for measurement initiation and measurement report correlation. Since the AMF 1008 may be configured to be the binding entity between the base station 1004 and the LMF 1006 in this example, it may be more efficient to configure the AMF 1008 to perform UE ID mapping between the base station 1004 and the LMF 1006.

For example, at 1014, after receiving the request for data collection/for initiating SRS measurements from the base station 1004, the AMF 1008 may be configured to create a routing ID for the measurement request (e.g., for a positioning session/NRPPa session). In some examples, the routing ID may be based on the NGAP UE ID, where the AMF 1008 may maintain a mapping of routing ID with NGAP UE ID over an NG interface.

At 1016, the AMF 1008 may create an LCS correlation ID to track the measurement request from the base station 1004 between the AMF 1008 and an LMF 1006. In some examples, at 1018, the AMF 1008 may select the LMF 1006 (e.g., via a network repository function (NRF) query). As an illustration, the base station 1004 (e.g., the serving gNB) may send an “Uplink UE Associated NRPPa Transport message” to the AMF 1008 (e.g., the serving AMF). The routing ID in this “Uplink UE Associated NRPPa Transport message” may be configured to be a special/reserved value to indicate to the AMF 1008 that this is a base station/gNB triggered NRPPa message. A range of routing ID values may be configured to be reserved for base station/gNB triggered NRPPa messages (e.g., a range of routing IDs which cannot be assigned by an AMF would enable the AMF to distinguish a routing ID assigned by a base station/gNB from routing IDs assigned by the AMF). The AMF 1008 may then assign an LCS session ID (e.g., a correlation ID) for this UE NGAP ID. The AMF 1008 may select a proper LMF (e.g., the LMF 1006) and provide the NRPPa message to the LMF, such as using a Namf_Communication_N2InfoNotify operation. Then, at 1020, the AMF 1008 may forward the request for data collection/for initiating SRS measurements from the base station 1004 to the LMF 1006 with the LCS correlation ID.

At 1022, based on receiving the request for data collection from the AMF 1008, the LMF 1006 may understand that the request is for data collection for AI/ML training in the base station 1004. In addition, the LMF 1006 may use the LCS correlation UD in subsequent NRPPa messages (and the AMF 1008 may use the routing ID in the NG NRPPa transport messages). In some examples, at 1024, if the request from the base station 1004 (e.g., at 1011) also specifies a ground truth label of the UE 1002 to be provided, the AMF 1008 may provide, to the base station 1004, the requested ground truth label, such as via an NGAP message. Alternatively, or in addition to, the base station 1004 may also request the LMF 1006 to provide the ground truth label, such as shown at 1026. In response, at 1128, the LMF 1006 may determine/generate the ground truth label for the UE 1002 and transmit the ground truth label to the base station 1004. Then, at 1030, the base station 1004 may use the received ground truth label for the AI/ML training.

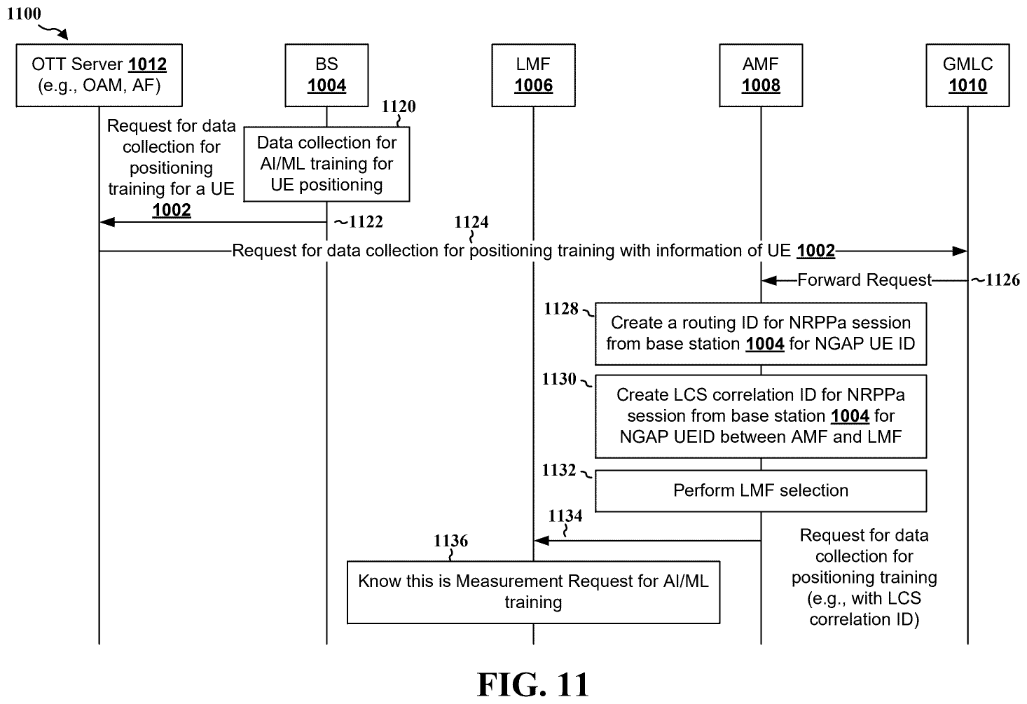

FIG. 11 is a communication flow 1100 illustrating an example procedure of a base station requesting for data collection related to AI/ML operation(s) for positioning in accordance with various aspects of the present disclosure. The numberings associated with the communication flow 1100 do not specify a particular temporal order and are merely used as references for the communication flow 1100. As discussed above, in another aspect of the present disclosure, for AI/ML-related operation(s) at a base station, such as AI/ML training, the base station may be configured with the capability to request an OAM entity or an external AI/ML service to trigger positioning measurements via a GMLC and the GMLC may forward the data collection request to the AMF. Then, the AMF may forward the request from the base station to the LMF to initiate positioning measurement.

In one example, a base station 1004 (e.g., the base station 706, which may also be referred to as a network entity depending on the context) may be associated with at least one AI/ML model that may be used for UE positioning (e.g., for determining the location of UE(s)). For example, the base station 1004 may use the at least one AI/ML model to assist measurements of SRSs transmitted from a UE 1002, such as described in connection with FIG. 9A (referring to as “SRS measurements” hereafter). Then, the base station 1004 may transmit the SRS measurements to an LMF 1006, and the LMF 1006 may determine the position of the UE 1002 based on the SRS measurements.

At 1120, if the base station 1004 specifies/demands data (e.g., SRS measurements) for training the at least one AI/ML model for UE positioning, as shown at 1122, the base station 1004 may be configured to transmit, to an over-the-top (OTT)/cloud server 1012, a request for data collection related to UE positioning/AI/ML training. The request may also be referred to as a request to initiate SRS measurements (e.g., for SRS transmitted from the UE 1002). The OTT/cloud server 1012 may act as an external client to a GMLC 1010 and request for data collection for positioning training with UE information. Depending on implementations, the OTT/cloud server 1012 may be an OAM entity or an application function (AF).

For example, at 1124, after receiving the request for data collection/for initiating SRS measurements from the base station 1004, the OTT/cloud server 1012 may forward the request for data collection/for initiating SRS measurements to the GMLC 1010 with information of the UE 1002. Information of the UE 1002 may primarily include a UE ID which both the OTT/cloud server 1012 and the GMLC 1010 are able to understand which UE is being referred (e.g., the UE 1002 in this example). Then, at 1126, the GMLC 1010 may forward, to the AMF 1008, the request for data collection/for initiating SRS measurements with the information of the UE 1002.

Similarly, at 1128, after receiving the request for data collection/for initiating SRS measurements with the information of the UE 1002 from the GMLC 1010, the AMF 1008 may be configured to create a routing ID for the measurement request (e.g., for a positioning session/NRPPa session). In some examples, the routing ID may be based on an NGAP UE ID, where the AMF 1008 may maintain a mapping of routing ID with NGAP UE ID over an NG interface as discussed in connection with FIG. 10.

At 1130, the AMF 1008 may create an LCS correlation ID to track the measurement request from the base station 1004 between the AMF 1008 and an LMF 1006. In some examples, at 1132, the AMF 1008 may select the LMF 1006 (e.g., via an NRF query). Then, at 1134, the AMF may forward the request for data collection/for initiating SRS measurements from the base station 1004 to the LMF 1006 with the LCS correlation ID.

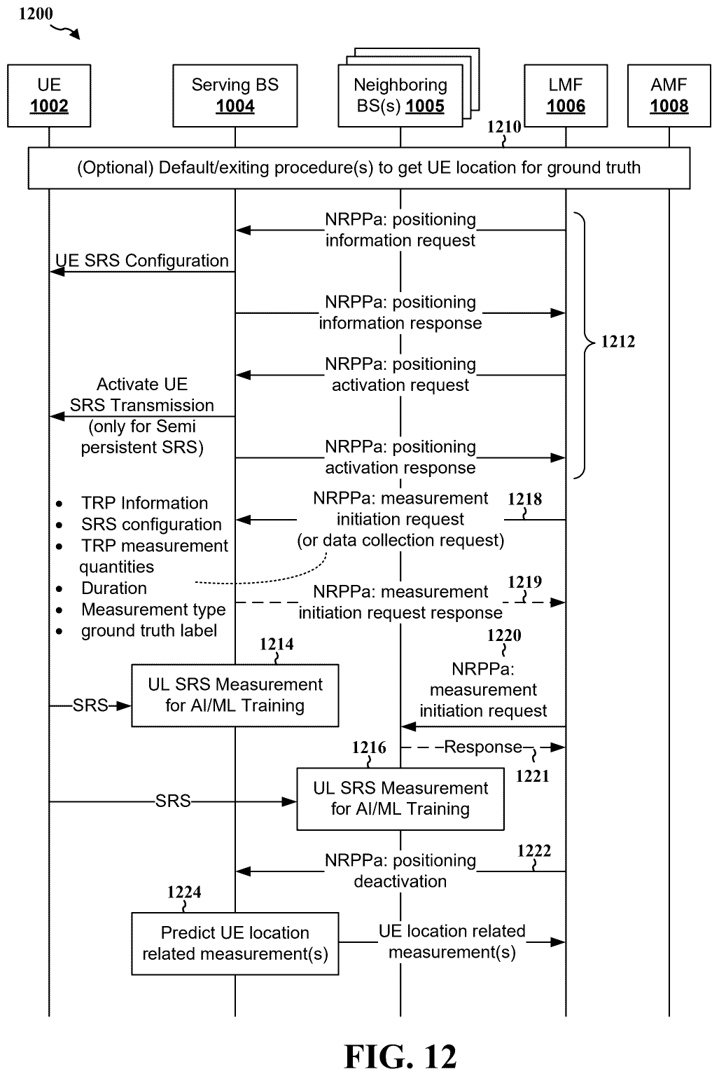

At 1136, based on receiving the request for data collection from the AMF 1008, the LMF 1006 may understand that the request is for data collection for AI/ML training in the base station 1004. In addition, the LMF 1006 may use the LCS correlation UD in subsequent NRPPa messages (and the AMF 1008 may use the routing ID in the NG NRPPa transport messages). In some examples, as discussed in connection with 1024 of FIG. 10, if the request also specifies a ground truth label of the UE 1002 to be provided, the LMF 1006 may also determine/generate the ground truth label for the UE 1002. Then, the LMF 1006 may initiate the SRS measurements for the base station 1004 (discussed in connection with FIG. 12 below).

FIG. 12 is a communication flow 1200 illustrating an example procedure of a base station requesting for data collection related to AI/ML operation(s) for positioning in accordance with various aspects of the present disclosure. The numberings associated with the communication flow 1200 do not specify a particular temporal order and are merely used as references for the communication flow 1200.

As discussed in connection with 1022 of FIG. 10 and 1136 of FIG. 11, based on receiving the request for data collection from the AMF 1008, the LMF 1006 may understand that the request from the base station 1004 (e.g., via the AMF 1008 or via the OTT/cloud server 1012 and GMLC 1010, etc.). In addition, the LMF 1006 may also understand that the base station 1004 may specify the ground truth label (of the UE 1002) for the AI/ML training along with the SRS measurements.

In one example, as shown at 1210, the LMF 1006 may be configured to trigger one or more default/existing positioning procedures in parallel to obtain the ground truth label of the UE 1002.

At 1212, the LMF 1006 may trigger a positioning information request (e.g., an NRPPa positioning information request) to obtain an SRS configuration from the base station 1004. For example, the base station 1004 (which may be the serving base station of the UE 1002) may configure the UE 1002 with an SRS configuration (e.g., the time/frequency resource(s) for the UE 1002 to transmit a set of SRSs). Then, at 1214, the UE 1002 may transmit/broadcast a set of SRSs to the base station 1004 based on the SRS configuration, and the base station 1004 may measure the set of SRSs (e.g., for data collection/AI/ML training purposes). In some examples, as shown at 1216, the UE 1002 may also be configured to transmit/broadcast a set of SRSs to one or more neighboring base stations 1005 (e.g., based on the SRS configuration), where the one or more neighboring base stations 1005 may also measure the set of SRSs (e.g., for data collection/AI/ML training purposes).

In some examples, at 1218 and 1220, the LMF 1006 may send a measurement initiation request message or data collection request message (collectively as the “measurement initiation request” or “measurement initiation request message” hereafter for ease of illustration) to the base station 1004 (e.g., the serving base station of the UE 1002) and the one or more neighboring base stations 1005 with one or more following information:
(1) TRP information (of the base station 1004/serving base station),
(2) the SRS configuration,
(3) the TRP measurement quantities,
(4) a duration for the measurement (e.g., for enabling the base station 1004/the one or more neighboring base stations 1005 to know how long the set of SRS from the UE 1002 may be used for the AI/ML training/data collection and/or when will the SRS transmission terminate, etc.),
(5) measurement type(s) (e.g., UL AoA, UL-RTOA, reception transmission time difference (RxTxTimeDiff), etc.), or
(6) ground truth label (if available/requested).

As an illustration, the LMF 1006 may send a NRPPa measurement initiation request message to the base station 1004 (e.g., the serving gNB of the UE 1002) and the one or more neighboring base stations 1005 (e.g., neighbor gNBs), which may include the location (e.g., the ground-truth label) of the UE 1002 obtained. Note a dedicated/new measurement type may be configured to indicate that this measurement request is for data collection, or this may be inferred from the presence of the “ground-truth label” in the message. Based on the measurement initiation request message, the base station 1004 and/or the one or more neighboring base stations 1005 may perform the SRS measurement(s) for the AI/ML training such as described in connection with 1214 and 1216. For example, the base station 1004 (e.g., the serving gNB of the UE 1002) and the one or more neighboring base stations 1005 (e.g., neighbor gNBs) may perform the UL SRS measurements and derive any data specified for model training. In some scenarios, it may be useful to send the one or more information above (e.g., UL SRS measurements collected, intermediate positioning related measurement predicted or derived, etc.) from the one or more neighboring base stations 1005 to the base station 1004 (e.g., the serving gNB) as the base station 1004 who initiates the data collection for AI/ML model training may demand more data samples for training from neighboring base stations 1005. In some examples, the base station 1004 may also be configured to send the one or more information above (e.g., the UL SRS measurements collected, intermediate positioning related measurement predicted or derived, etc.) to the one or more neighboring base stations 1005. In some implementations, as shown at 1219 and 1221, in response to the measurement initiation request message from the LMF 1006, the base station 1004 and/or the one or more neighboring base stations 1005 may send a response message (e.g., an NRPPa measurement response message) to the LMF 1006 without measurements indicating that the data collection for model training has finished. This may be for example an empty choice in a TRP measurement result. For examples above, the base station 1004 (e.g., the serving gNB) may be configured with the capability to make the “data collection request” also on behalf of neighbor base stations/TRPs. It may be up to the neighbor base stations/TRPs to perform the data collection or not (e.g., based on the UE/PRU ground-truth location, etc.).

In some examples, at 1222, the LMF 1006 may also have the capability to end the AI/ML training/data collection at the base station 1004, such as by transmitting a deactivation message to the base station 1004. In another example, as shown at 1224, the base station 1004 may also be configured to predict location related measurement(s) of the UE 1002 such as the AoA, RxTxTimeDiff, etc. Then, the base station 1004 may provide the predicted location related measurement(s) of the UE 1002 to the LMF 1006 for the LMF 1006 to derive the location of the UE 1002 (e.g., for indirect positioning as described in connection with FIG. 9B).

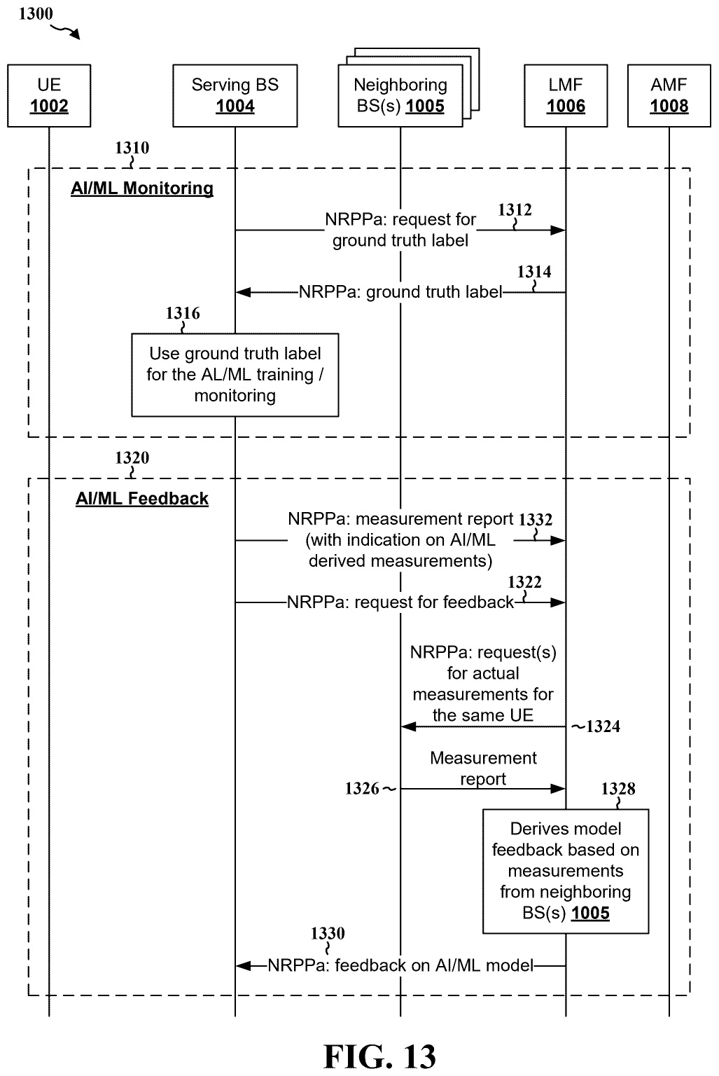

FIG. 13 is a communication flow 1300 illustrating an example procedure of a base station requesting ground truth label and feedback related to AI/ML operation(s) for positioning in accordance with various aspects of the present disclosure. The numberings associated with the communication flow 1300 do not specify a particular temporal order and are merely used as references for the communication flow 1300. As discussed above, in some scenarios, a base station may specify the ground truth label of a UE from an LMF for AI/ML training and model validation, which may not be available in current/existing NRPPa messages. Also, in some scenarios, a base station may want to receive feedback of an AI/ML model from an LMF, as the LMF may be aware of the ground truth and may validate the performance of the AI/ML model in a base station.

In one aspect of the present disclosure, as shown at 1310, when the base station 1004 specifies a ground truth label (of the UE 1002) for the AI/ML training and/or monitoring, and if the LMF 1006 already has the ground truth label, the base station 1004 may send a request for ground truth label along with the measurement initiation message or as an independent request (e.g., the ground truth request may be transmitted in the same message as the measurement initiation request message, or they may be transmitted in separated messages), such as described in connection with 1012 of FIG. 10. For example, at 1312, if the base station 1004 does not have ground truth label (of the UE 1002), the base station 1004 may transmit, to the LMF 1006, a request for a ground truth label (of the UE 1002). Depending on implementations, the base station 1004 may request the LMF 1006 for the ground truth label using the same routing ID as NRPPa messages for AI/ML training (e.g., discussed in connection with 1014 of FIG. 10 and 1128 of FIG. 11). In some examples, the request may be configured to be subscription based.

At 1314, in response to the request for the ground truth label, the LMF 1006 may provide the ground truth label (of the UE 1002) to the base station 1004. In some implementations, the ground truth label may also include related data, such as the time stamp. For example, the LMF 1006 may send the ground truth label with a time stamp to the base station 1004, such as via an NRPPa message or an NGAP. Then, at 1316, the base station 1004 may use the ground truth label (of the UE 1002) (and optionally the related data such as the time stamp if available) for the AI/ML training/monitoring (e.g., based on SRS(s) transmitted from the UE 1002).

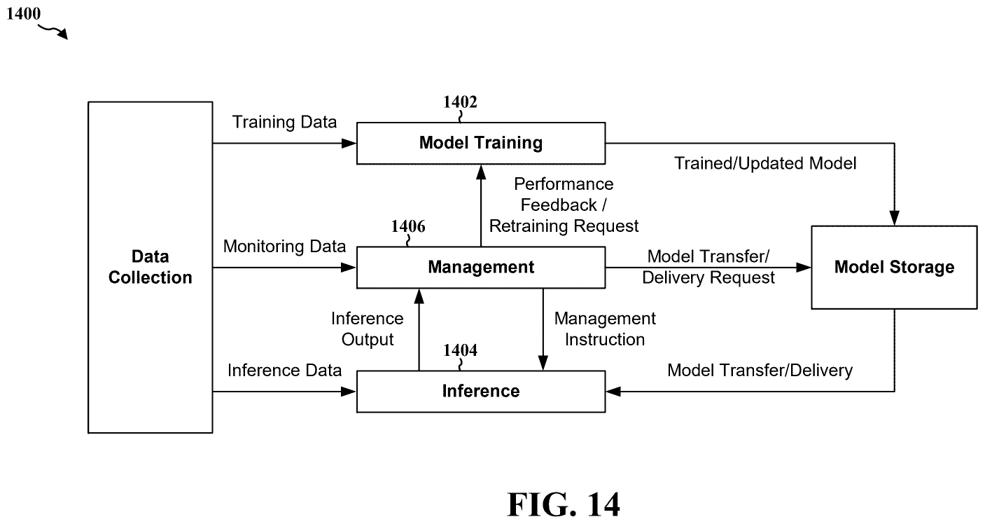

FIG. 14 is a diagram 1400 illustrating an example data monitoring related to AI/ML air interface and AI/ML positioning in accordance with various aspects of the present disclosure. In some implementations, as shown at 1406, in addition to performing AI/ML data training at 1402 and/or data inferencing at 1404, an AI/ML model may also be configured to perform data monitoring. For purposes of the present disclosure, at a high-level, AI/ML performance monitoring, AI/ML model monitor, and/or AI/ML data monitoring, etc. (collectively as “AI/ML monitoring” hereafter) may refer to monitoring the overall quality of at least one AI/ML model, which may also include monitoring inputs for the at least one AI/ML model and/or outputs from the at least one AI/ML model. For example, AI/ML monitoring may include monitoring the accuracy of positioning or positioning measurements performed by an AI/ML model, monitoring data that is used for training an AI/ML model, monitoring whether an AI/ML model is suitable under a set of specified conditions or under a specified environment, etc. There may be a variety of configurations for AI/ML model monitoring in lifecycle management, which may include: (1) monitoring based on inference accuracy (including metrics related to intermediate key performance indicators (KPIs)), (2) monitoring based on system performance (including metrics related to system performance KPIs), (3) monitoring based on data distribution, which may be input-based, e.g., monitoring the validity of the AI/ML input, e.g., out-of-distribution detection, drift detection of input data, or SNR, delay spread, etc., and/or output-based: e.g., drift detection of output data, (4) monitoring based on applicable condition. The monitoring metric calculation may be performed at the network (e.g., an LMF, a base station, etc.) or at the UE.

Referring back to FIG. 13. In another aspect of the present disclosure, as shown at 1320, the base station 1004 may request feedback related to an AI/ML model from the LMF 1006, such for training, retraining, and/or fine-turning the AI/ML model (e.g., for improving the accuracy of the AI/ML model). For example, at 1322, the base station 1004 may transmit, to the LMF 1006, a request for feedback for one or more AI/ML models (e.g., AI/ML model(s) used by the base station 1004 for UE positioning).

In some examples, the LMF 1006 may be configured to use default/existing positioning mechanisms (e.g., as discussed in connection with FIG. 4) to obtain measurements from the neighboring base stations for the same UE. For example, at 1324, the LMF 1006 may request the one or more neighboring base stations 1005 to measure SRS(s) transmitted from the UE 1002 (e.g., as discussed in connection with 1216 of FIG. 12). At 1326, in response to the request, each of the one or more neighboring base stations 1005 may measure the SRS(s) transmitted from the UE 1002 and transmit an SRS measurement report to the LMF 1006. At 1328, the LMF 1006 may use the measurement reports from the one or more neighboring base stations 1005 to derive the feedback for the one or more AI/ML models. Then, at 1330, the LMF may transmit the derived feedback for the one or more AI/ML models to the base station 1004.

In another aspect of the present disclosure, the base station 1004 may also be configured to indicate whether measurement(s) in a measurement report are actual measurements or AI/ML derived measurements, which may be used for improving the overall UE positioning at the LMF 1006. In a non-AI/ML positioning scenario, based on the UL SRS measured by TRP(s) of a base station, the base station may derive positioning related measurements such as the AoA, RxTxTimeDiff, and/or RTOA measurements, etc. and send the derived positioning related measurements to an LMF. On other hand, for an AI/ML positioning scenario (e.g., when at least one of the positioning entities is configured with the AI/ML capability such as the base station), a base station with the AI/ML capability may derive the positioning related measurements such as AoA, RxTxTimeDiff, and/or RTOA, etc. based on an AI/ML model/algorithm after measuring the SRS received at the TRP, which may be referred to as the “AI/ML derived measurements”. For example, at 1332, the base station 1004 may indicate in a measurement report (e.g., an NRPPa measurement report for reporting measurement of SRS(s) from a UE) that whether the measurement(s) in the measurement report are actual measurements or AI/ML derived measurements. In some examples, if the measurement(s) are AI/ML derived measurements, the LMF 1006 may also be configured to use this information (e.g., the AI/ML derived measurements) to provide feedback to the base station 1004 regarding the AI/ML model performance (e.g., the performance for the AI/ML model that derives the measurement(s)), such as via a feedback message at 1330.

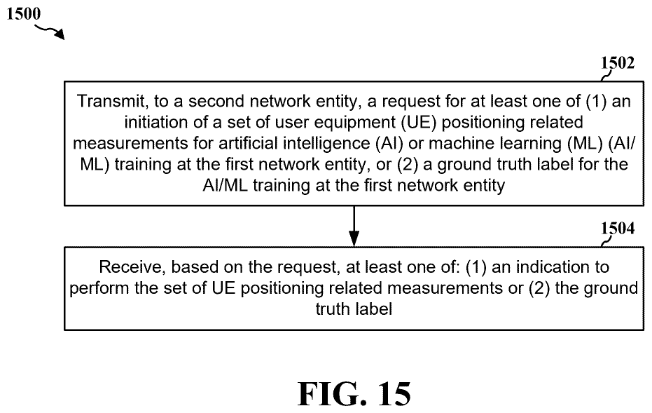

FIG. 15 is a flowchart 1500 of wireless communication. The method may be performed by a first network entity (e.g., the base station 102, 706, 1004; the network entity 1602). The method may enable the first network entity (e.g., a base station) to request a second network entity (e.g., an LMF) to initiate/trigger positioning measurements at the first network entity via an AMF, an OAM entity, and/or an external AI/ML service.

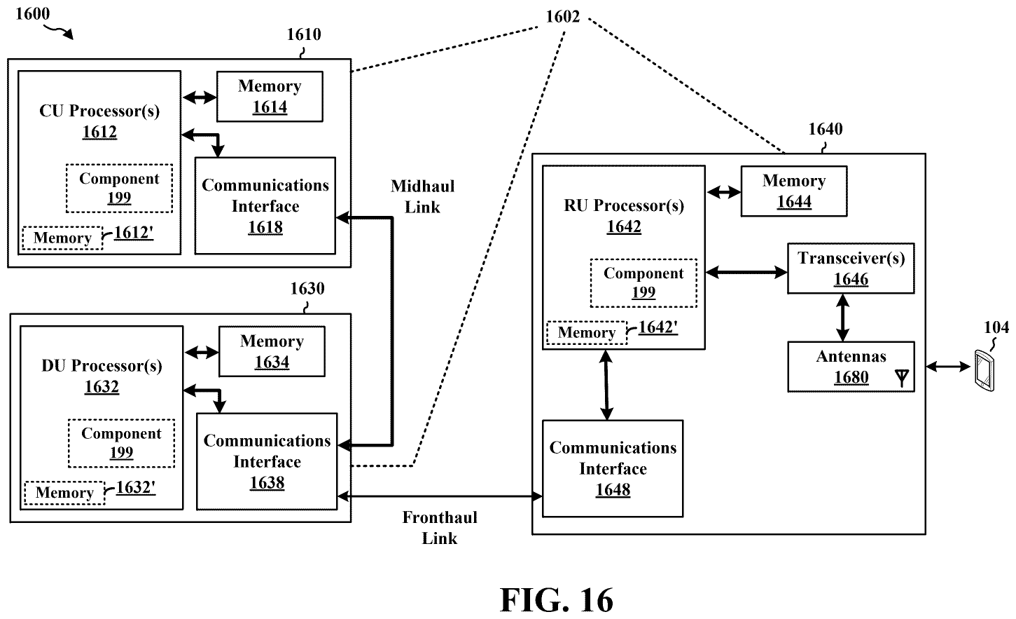

At 1502, a first network entity may transmit, to a second network entity, a request for at least one of (1) an initiation of a set of UE positioning related measurements for AI/ML training at the first network entity, or (2) a ground truth label for the AI/ML training at the first network entity, such as described in connection with FIGS. 10 to 13. For example, as discussed in connection with 1012 of FIG. 10, the base station 1004 may be configured to transmit, to an AMF 1008, a request for data collection related to UE positioning/AI/ML training. The request may also be referred to as a request to initiate SRS measurements (e.g., for SRS transmitted from the UE 1002). Depending on implementations, the request may include one or more of: (1) a set of NGAP UE IDs (e.g., an identifier that is used to identify the UE 1002 or a set of identifiers that is used to identify a set of UEs in the AMF 1008 on an N2 reference point), (2) a request for ground truth label, (3) a request for feedback (e.g., for the at least one AI/ML model), (4) a duration related to the data collection (e.g., a duration for the base station 1004 to collect data), (5) a request/indication for measurement type (e.g., AoA, TDoA, etc.), and/or (6) SRS characteristics related to AI/ML model(s) being trained (e.g., SRS characteristics may include transmission comb(s), a start position, a number of symbols, a frequency domain shift, a cell-specific SRS bandwidth configuration parameter C-SRS, resource type positioning, etc.). The transmission of the request may be performed by, e.g., the data collection initiation component 199, the transceiver(s) 1646, the RU processor(s) 1642, the DU processor(s) 1632, and/or the CU processor(s) 1612, of the network entity 1602 in FIG. 16.

At 1504, the first network entity may receive, based on the request, at least one of: (1) an indication to perform the set of UE positioning related measurements or (2) the ground truth label, such as described in connection with FIGS. 10 to 13. For example, as discussed in connection with 1218 of FIG. 12, the base station 1004 may receive, from the LMF 1006, a measurement initiation message. As discussed in connection with 1314 of FIG. 13, in response to the request for the ground truth label, the base station 1004 may receive the ground truth label (of the UE 1002) from the LMF 1006. The reception of the indication and/or the ground truth label may be performed by, e.g., the data collection initiation component 199, the transceiver(s) 1646, the RU processor(s) 1642, the DU processor(s) 1632, and/or the CU processor(s) 1612, of the network entity 1602 in FIG. 16.

In one example, the reception of the indication to perform the set of UE positioning related measurements is based on transmission of the request for the initiation of the set of UE positioning related measurements for the AI/ML training at the first network entity. In some implementations, the second network entity is an AMF or a GMLC.

In another example, the indication to perform the set of UE positioning related measurements corresponds to a configuration for a set of SRSs to be transmitted from at least one UE.

In another example, the request for the initiation of the set of UE positioning related measurements further includes at least one of: a second indication to provide a feedback for at least one AI/ML model associated with the AI/ML training, a duration for the at least one AI/ML model to be used for the AI/ML training, a measurement type for the at least one AI/ML model to be used for the AI/ML training, or a set of SRSs characteristic associated with the at least one AI/ML model.

In another example, the request for the initiation of the set of UE positioning related measurements further includes a NGAP ID of a UE, and the first network entity may receive, from an LMF, one or more NRPPa messages with an LCS correlation ID, where the LCS correlation ID is derived based on the NGAP ID of the UE. In some implementations, the first network entity is a base station and the second network entity is an AMF.

In another example, the reception of the ground truth label is based on transmission of the request for the ground truth label for the AI/ML training at the first network entity. In some implementations, the ground truth label is received via at last one of an NRPPa message or an NGAP message, and includes at last one of a routing ID, a correlation ID, or at least one ID of at least one user UE (e.g., if the ground truth label is received via an NRPPa message, then the ground truth label may include a routing ID and a correlation ID, if the ground truth label is received via an NGAP message, then the ground truth label may include just the UE ID(s)). In some implementations, the first network entity may perform the AI/ML training or AI/ML monitoring based on the ground truth label.

In another example, the ground truth label corresponds to a location of a UE derived by the second network entity or a true UE position obtained based on a set of SRSs measurements.

In another example, the first network entity may transmit, to the second network entity, a measurement report associated with the set of UE positioning related measurements, where the measurement report indicates whether the set of UE positioning related measurements is based on an actual measurement or an AI/ML derived measurement, and receive, from the second network entity, a feedback related to the measurement report.

In another example, the request further includes a second indication to provide a feedback for at least one AI/ML model associated with the AI/ML training, and the first network entity may receive, from the second network entity, the feedback related to the at least one AI/ML model.

In another example, the request for the initiation of the set of UE positioning related measurements is separate from the request for the ground truth label.

In another example, the first network entity may receive, from an LMF, a measurement initiation message that includes at least one of: (1) TRP information, (2) a set of SRS configurations, (3) a set of TRP measurement quantities, (4) a duration for measurement, (5) a set of measurement types, or (6) a ground truth label.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the data collection initiation component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the data collection initiation component 199 may be configured to transmit, to a second network entity, a request for at least one of (1) an initiation of a set of UE positioning related measurements for AI/ML training at the first network entity, or (2) a ground truth label for the AI/ML training at the first network entity. The data collection initiation component 199 may also be configured to receive, based on the request, at least one of: (1) an indication to perform the set of UE positioning related measurements or (2) the ground truth label. The data collection initiation component 199 may be within one or more processors of one or more of the CU 1610, DU 1630, and the RU 1640. The data collection initiation component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for transmitting, to a second network entity, a request for at least one of (1) an initiation of a set of UE positioning related measurements for AI/ML training at the network entity 1602, or (2) a ground truth label for the AI/ML training at the network entity 1602. The network entity 1602 may further include means for receiving, based on the request, at least one of: (1) an indication to perform the set of UE positioning related measurements or (2) the ground truth label.

In one configuration, the reception of the indication to perform the set of UE positioning related measurements is based on transmission of the request for the initiation of the set of UE positioning related measurements for the AI/ML training at the network entity 1602. In some implementations, the second network entity is an AMF or a GMLC.

In another configuration, the indication to perform the set of UE positioning related measurements corresponds to a configuration for a set of SRSs to be transmitted from at least one UE.

In another configuration, the request for the initiation of the set of UE positioning related measurements further includes at least one of: a second indication to provide a feedback for at least one AI/ML model associated with the AI/ML training, a duration for the at least one AI/ML model to be used for the AI/ML training, a measurement type for the at least one AI/ML model to be used for the AI/ML training, or a set of SRSs characteristic associated with the at least one AI/ML model.

In another configuration, the request for the initiation of the set of UE positioning related measurements further includes a NGAP ID of a UE, and the network entity 1602 may further include means for receiving, from an LMF, one or more NRPPa messages with an LCS correlation ID, where the LCS correlation ID is derived based on the NGAP ID of the UE. In some implementations, the network entity 1602 is a base station and the second network entity is an AMF.

In another configuration, the reception of the ground truth label is based on transmission of the request for the ground truth label for the AI/ML training at the network entity 1602. In some implementations, the ground truth label is received via at last one of an NRPPa message or an NGAP message, and includes at least one of a routing ID, a correlation ID, or at least one ID of at least one user UE (e.g., derived based on an ID of a UE). In some implementations, the network entity 1602 may further include means for performing the AI/ML training or AI/ML monitoring based on the ground truth label.

In another configuration, the ground truth label corresponds to a location of a UE derived by the second network entity or a true UE position obtained based on a set of SRSs measurements.

In another configuration, the network entity 1602 may further include means for transmitting, to the second network entity, a measurement report associated with the set of UE positioning related measurements, where the measurement report indicates whether the set of UE positioning related measurements is based on an actual measurement or an AI/ML derived measurement, and means for receiving, from the second network entity, a feedback related to the measurement report.

In another configuration, the request further includes a second indication to provide a feedback for at least one AI/ML model associated with the AI/ML training, and the network entity 1602 may further include means for receiving, from the second network entity, the feedback related to the at least one AI/ML model.

In another configuration, the request for the initiation of the set of UE positioning related measurements is separate from the request for the ground truth label.

In another configuration, the network entity 1602 may further include means for receiving, from an LMF, a measurement initiation message that includes at least one of: (1) TRP information, (2) a set of SRS configurations, (3) a set of TRP measurement quantities, (4) a duration for measurement, (5) a set of measurement types, or (6) a ground truth label.

The means may be the data collection initiation component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

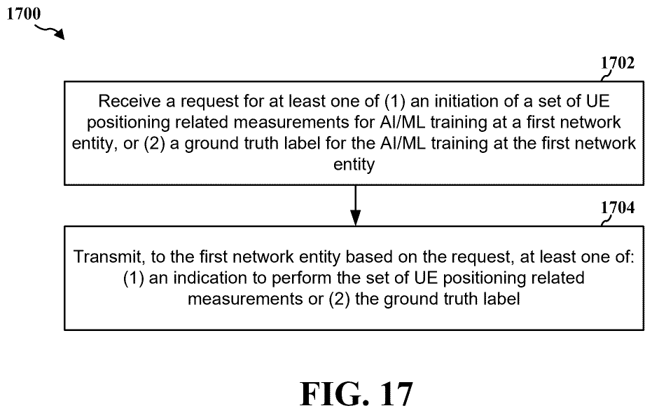

FIG. 17 is a flowchart 1700 of a method of wireless communication. The method may be performed by a second network entity (e.g., the one or more location servers 168; the location server 704; the LMF 1006; the network entity 1860). The method may enable the second network entity (e.g., an LMF) to initiate/trigger positioning measurements for a first network entity (e.g., a base station) based on the request from the first network entity via an AMF, an OAM entity, and/or an external AI/ML service.

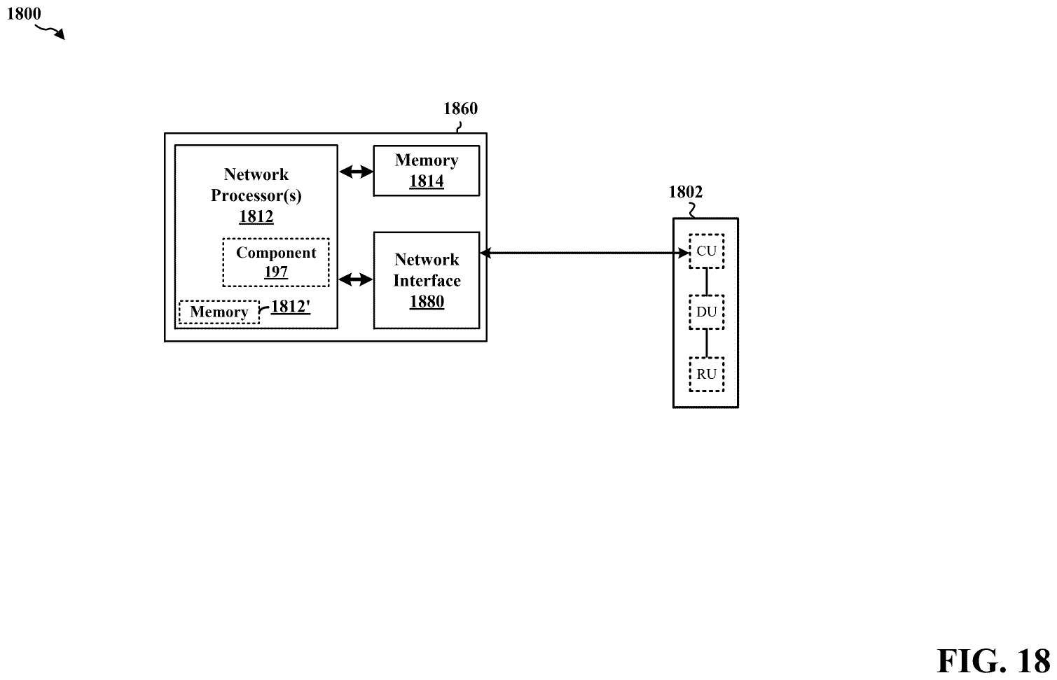

At 1702, a second network entity may receive a request for at least one of (1) an initiation of a set of UE positioning related measurements for AI/ML training at a first network entity, or (2) a ground truth label for the AI/ML training at the first network entity, such as described in connection with FIGS. 10 to 13. For example, as discussed in connection with 1020 of FIG. 10, the LMF 1006 may receive, from the AMF 1008, the request for data collection/for initiating SRS measurements at the base station 1004 with the LCS correlation ID. As discussed in connection with 1312 of FIG. 13, the LMF 1006 may receive, from the base station 1004, a request for a ground truth label (of the UE 1002). The reception of the request may also be performed by, e.g., the data collection process component 197, the network processor(s) 1812, and/or the network interface 1880 of the network entity 1860 in FIG. 18.

At 1704, the second network entity may transmit, to the first network entity based on the request, at least one of: (1) an indication to perform the set of UE positioning related measurements or (2) the ground truth label, such as described in connection with FIGS. 10 to 13. For example, as discussed in connection with 1218 of FIG. 12, the LMF 1006 may send a measurement initiation message to the base station 1004 (e.g., the serving base station of the UE 1002). As discussed in connection with 1314 of FIG. 13, in response to the request for the ground truth label, the LMF 1006 may provide the ground truth label (of the UE 1002) to the base station 1004. The transmission of the indication and/or the ground truth label may also be performed by, e.g., the data collection process component 197, the network processor(s) 1812, and/or the network interface 1880 of the network entity 1860 in FIG. 18.

In one example, the transmission of the indication to perform the set of UE positioning related measurements is based on reception of the request for the initiation of the set of UE positioning related measurements for the AI/ML training at the first network entity. In some examples, to receive the request, the second network entity may be configured to receive the request from the first network entity via an AMF or a GMLC.

In another example, the indication to perform the set of UE positioning related measurements corresponds to a configuration for a set of SRSs to be transmitted from at least one UE.

In another example, the request for the initiation of the set of UE positioning related measurements further includes at least one of: a second indication to provide a feedback for at least one AI/ML model associated with the AI/ML training, a duration for the at least one AI/ML model to be used for the AI/ML training, a measurement type for the at least one AI/ML model to be used for the AI/ML training, or a set of SRSs characteristic associated with the at least one AI/ML model.

In another example, the request for the initiation of the set of UE positioning related measurements further includes an LCS correlation ID, and the second network entity may transmit, to the first network entity, one or more NRPPa messages with the LCS correlation ID. In some implementations, the second network entity is an AMF, and the first network entity is a base station.

In another example, the transmission of the ground truth label is based on reception of the request for the ground truth label for the AI/ML training. In some implementations, the ground truth label is transmitted via at last one of an NRPPa message or an NGAP message, and includes a routing ID and a correlation ID, where the correlation ID may be derived based on at least one ID of at least one user UE (e.g., derived based on an ID of a UE). In some implementations, the ground truth label includes a routing ID and an LCS correlation ID, where the LCS correlation ID is derived based on an NGAP ID of a UE.

In another example, the ground truth label corresponds to a location of a UE derived by the second network entity or a true UE position obtained based on a set of SRSs measurements.

In another example, the second network entity may receive, from the first network entity, a measurement report associated with the set of UE positioning related measurements, where the measurement report indicates whether the set of UE positioning related measurements is based on an actual measurement or an AI/ML derived measurement, and transmit, to the first network entity, a feedback related to the measurement report.

In another example, the request further includes a second indication to provide a feedback for at least one AI/ML model associated with the AI/ML training, and the second network entity may be configured to transmit, to the first network entity, the feedback related to the at least one AI/ML model.

In another example, the request for the initiation of the set of UE positioning related measurements is separate from the request for the ground truth label.

FIG. 18 is a diagram 1800 illustrating an example of a hardware implementation for a network entity 1860. In one example, the network entity 1860 may be within the core network 120. The network entity 1860 may include at least one network processor 1812. The network processor(s) 1812 may include on-chip memory 1812′. In some aspects, the network entity 1860 may further include additional memory modules 1814. The network entity 1860 communicates via the network interface 1880 directly (e.g., backhaul link) or indirectly (e.g., through a RIC) with the CU 1802. The on-chip memory 1812′ and the additional memory modules 1814 may each be considered a computer-readable medium/memory. Each computer-readable medium/memory may be non-transitory. The network processor(s) 1812 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the data collection process component 197 may be configured to receive a request for at least one of (1) an initiation of a set of UE positioning related measurements for AI/ML training at a first network entity, or (2) a ground truth label for the AI/ML training at the first network entity. The data collection process component 197 may also be configured to transmit, to the first network entity based on the request, at least one of: (1) an indication to perform the set of UE positioning related measurements or (2) the ground truth label. The data collection process component 197 may be within the network processor(s) 1812. The data collection process component 197 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1860 may include a variety of components configured for various functions. In one configuration, the network entity 1860 may include means for receiving a request for at least one of (1) an initiation of a set of UE positioning related measurements for AI/ML training at a first network entity, or (2) a ground truth label for the AI/ML training at the first network entity. The network entity 1860 may further include means for transmitting, to the first network entity based on the request, at least one of: (1) an indication to perform the set of UE positioning related measurements or (2) the ground truth label.

In one configuration, the transmission of the indication to perform the set of UE positioning related measurements is based on reception of the request for the initiation of the set of UE positioning related measurements for the AI/ML training at the first network entity. In some configurations, to receive the request, the network entity 1860 may be configured to receive the request from the first network entity via an AMF or a GMLC.

In another configuration, the indication to perform the set of UE positioning related measurements corresponds to a configuration for a set of SRSs to be transmitted from at least one UE.

In another configuration, the request for the initiation of the set of UE positioning related measurements further includes at least one of: a second indication to provide a feedback for at least one AI/ML model associated with the AI/ML training, a duration for the at least one AI/ML model to be used for the AI/ML training, a measurement type for the at least one AI/ML model to be used for the AI/ML training, or a set of SRSs characteristic associated with the at least one AI/ML model.

In another configuration, the request for the initiation of the set of UE positioning related measurements further includes an LCS correlation ID, and the network entity 1860 may further include means for transmitting, to the first network entity, one or more NRPPa messages with the LCS correlation ID. In some implementations, the network entity 1860 is an AMF, and the first network entity is a base station.

In another configuration, the reception of the ground truth label is based on transmission of the request for the ground truth label for the AI/ML training at the first network entity. In some implementations, the ground truth label is received via at last one of an NRPPa message or an NGAP message, and includes at least one of a routing ID, a correlation ID, or at least one ID of at least one user UE. In some implementations, the ground truth label includes a routing ID and an LCS correlation ID, where the LCS correlation ID is derived based on an NGAP ID of a UE.

In another configuration, the ground truth label corresponds to a location of a UE derived by the network entity 1860 or a true UE position obtained based on a set of SRSs measurements.

In another configuration, the network entity 1860 may further include means for receiving, from the first network entity, a measurement report associated with the set of UE positioning related measurements, where the measurement report indicates whether the set of UE positioning related measurements is based on an actual measurement or an AI/ML derived measurement, and means for transmitting, to the first network entity, a feedback related to the measurement report.

In another configuration, the request further includes a second indication to provide a feedback for at least one AI/ML model associated with the AI/ML training, and the network entity 1860 may further include means for transmitting, to the first network entity, the feedback related to the at least one AI/ML model.

In another configuration, the request for the initiation of the set of UE positioning related measurements is separate from the request for the ground truth label.

The means may be the data collection process component 197 of the network entity 1860 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network entity, comprising: transmitting, to a second network entity, a request for at least one of (1) an initiation of a set of UE positioning related measurements for artificial intelligence (AI) or machine learning (ML) (AI/ML) training at the first network entity, or (2) a ground truth label for the AI/ML training at the first network entity; and receiving, based on the request, at least one of: (1) an indication to perform the set of UE positioning related measurements or (2) the ground truth label.

Aspect 2 is the method of aspect 1, wherein reception of the indication to perform the set of UE positioning related measurements is based on transmission of the request for the initiation of the set of UE positioning related measurements for the AI/ML training at the first network entity.

Aspect 3 is the method of aspect 1 or aspect 2, wherein the second network entity is an access and mobility management function (AMF) or a gateway mobile location center (GMLC).

Aspect 4 is the method of any of aspects 1 to 3, wherein the indication to perform the set of UE positioning related measurements corresponds to a configuration for a set of sounding reference signals (SRS) to be transmitted from at least one user equipment (UE).

Aspect 5 is the method of any of aspects 1 to 4, wherein the request for the initiation of the set of UE positioning related measurements further includes at least one of: a second indication to provide a feedback for at least one AI/ML model associated with the AI/ML training, a duration for the at least one AI/ML model to be used for the AI/ML training, a measurement type for the at least one AI/ML model to be used for the AI/ML training, or a set of sounding reference signals (SRSs) characteristic associated with the at least one AI/ML model.

Aspect 6 is the method of any of aspects 1 to 5, the request for the initiation of the set of UE positioning related measurements further includes at least one identifier (ID) of at least one user equipment (UE) that can be used for identifying the at least one UE over a New Generation (NG) interface, the method comprises: receiving, from a location management function (LMF), one or more New Radio Positioning Protocol A (NRPPa) messages with a correlation ID, wherein the correlation ID is derived based on the at least one ID of the at least one UE.

Aspect 7 is the method of any of aspects 1 to 6, wherein the first network entity is a base station and the second network entity is an access and mobility management function (AMF).

Aspect 8 is the method of any of aspects 1 to 7, wherein reception of the ground truth label is based on transmission of the request for the ground truth label for the AI/ML training at the first network entity.

Aspect 9 is the method of any of aspects 1 to 8, wherein the ground truth label is received via at last one of a New Radio Positioning Protocol A (NRPPa) message or a Next Generation Access Point (NGAP) message, including at least one of a routing identifier (ID), a correlation ID, or at least one ID of at least one user equipment (UE).

Aspect 10 is the method of any of aspects 1 to 9, further comprising: performing the AI/ML training or AI/ML monitoring based on the ground truth label.

Aspect 11 is the method of any of aspects 1 to 10, wherein the ground truth label corresponds to a location of a user equipment (UE) derived by the second network entity or a true UE position obtained based on a set of sounding reference signals (SRSs) measurements.

Aspect 12 is the method of any of aspects 1 to 11, further comprising: transmitting, to the second network entity, a measurement report associated with the set of UE positioning related measurements, wherein the measurement report indicates whether the set of UE positioning related measurements is based on an actual measurement or an AI/ML derived measurement; and receiving, from the second network entity, a feedback related to the measurement report.

Aspect 13 is the method of any of aspects 1 to 12, wherein the request further includes a second indication to provide a feedback for at least one AI/ML model associated with the AI/ML training, the method further comprises: receiving, from the second network entity, the feedback related to the at least one AI/ML model.

Aspect 14 is the method of any of aspects 1 to 13, further comprising: receiving, from a location management function (LMF), a measurement initiation message that includes at least one of: (1) transmission reception point (TRP) information, (2) a set of sounding reference signal (SRS) configurations, (3) a set of TRP measurement quantities, (4) a duration for measurement, (5) a set of measurement types, or (6) a ground truth label.

Aspect 15 is an apparatus for wireless communication at a first network entity, including: at least one memory; and at least one processor coupled to the at least one memory and, based at least in part on stored information that is stored in the at least one memory, the at least one processor, individually or in any combination, is configured to implement any of aspects 1 to 14.

Aspect 16 is the apparatus of aspect 15, further including at least one transceiver coupled to the at least one processor.

Aspect 17 is an apparatus for wireless communication at a first network entity including means for implementing any of aspects 1 to 14.

Aspect 18 is a computer-readable medium (e.g., a non-transitory computer-readable medium) storing computer executable code, where the code when executed by a processor causes the processor to implement any of aspects 1 to 14.

Aspect 19 is a method of wireless communication at a second network entity, comprising: receiving a request for at least one of (1) an initiation of a set of UE positioning related measurements for artificial intelligence (AI) or machine learning (ML) (AI/ML) training at a first network entity, or (2) a ground truth label for the AI/ML training at the first network entity; and transmitting, to the first network entity based on the request, at least one of: (1) an indication to perform the set of UE positioning related measurements or (2) the ground truth label.

Aspect 20 is the method of aspect 19, wherein transmission of the indication to perform the set of UE positioning related measurements is based on reception of the request for the initiation of the set of UE positioning related measurements for the AI/ML training at the first network entity.

Aspect 21 is the method of aspect 19 or aspect 20, wherein receiving the request comprises receiving the request from the first network entity via an access and mobility management function (AMF) or a gateway mobile location center (GMLC).

Aspect 22 is the method of any of aspects 19 to 21, wherein the indication to perform the set of UE positioning related measurements corresponds to a configuration for a set of sounding reference signals (SRS) to be transmitted from at least one user equipment (UE).

Aspect 23 is the method of any of aspects 19 to 22, wherein the request for the initiation of the set of UE positioning related measurements further includes at least one of: a second indication to provide a feedback for at least one AI/ML model associated with the AI/ML training, a duration for the at least one AI/ML model to be used for the AI/ML training, a measurement type for the at least one AI/ML model to be used for the AI/ML training, or a set of sounding reference signals (SRSs) characteristic associated with the at least one AI/ML model.

Aspect 24 is the method of any of aspects 19 to 23, wherein the request for the initiation of the set of UE positioning related measurements further includes a location service (LCS) correlation ID, the method comprises: transmitting, to the first network entity, one or more New Radio Positioning Protocol A (NRPPa) messages with the LCS correlation ID.

Aspect 25 is the method of any of aspects 19 to 24, wherein the second network entity is an access and mobility management function (AMF) and the first network entity is a base station.

Aspect 26 is the method of any of aspects 19 to 25, wherein transmission of the ground truth label is based on reception of the request for the ground truth label for the AI/ML training at the first network entity.

Aspect 27 is the method of any of aspects 19 to 26, wherein the ground truth label includes a routing identifier (ID) and a location service (LCS) correlation ID, wherein the LCS correlation ID is derived based on a Next Generation Access Point (NGAP) ID of a user equipment (UE).

Aspect 28 is the method of any of aspects 19 to 27, wherein the ground truth label corresponds to a location of a user equipment (UE) derived by the second network entity or a true UE position obtained based on a set of sounding reference signals (SRSs) measurements.

Aspect 29 is the method of any of aspects 19 to 28, further comprising: receiving, from the first network entity, a measurement report associated with the set of UE positioning related measurements, wherein the measurement report indicates whether the set of UE positioning related measurements is based on an actual measurement or an AI/ML derived measurement; and transmitting, to the first network entity, a feedback related to the measurement report.

Aspect 30 is the method of any of aspects 19 to 29, wherein the request further includes a second indication to provide a feedback for at least one AI/ML model associated with the AI/ML training, the method further comprises: transmitting, to the first network entity, the feedback related to the at least one AI/ML model.

Aspect 31 is the method of any of aspects 19 to 30, wherein the request for the initiation of the set of UE positioning related measurements is separate from the request for the ground truth label.

Aspect 32 is an apparatus for wireless communication at a second network entity, including: at least one memory; and at least one processor coupled to the at least one memory and, based at least in part on stored information that is stored in the at least one memory, the at least one processor, individually or in any combination, is configured to implement any of aspects 19 to 31.

Aspect 33 is the apparatus of aspect 32, further including at least one network interface coupled to the at least one processor.

Aspect 34 is an apparatus for wireless communication at a second network entity including means for implementing any of aspects 19 to 31.

Aspect 35 is a computer-readable medium (e.g., a non-transitory computer-readable medium) storing computer executable code, where the code when executed by a processor causes the processor to implement any of aspects 19 to 31.

What is claimed is:

1. An apparatus for wireless communication at a first network entity, comprising:
at least one memory; and
at least one processor coupled to the at least one memory, the at least one processor, individually or in any combination, is configured to:
transmit, to a second network entity, a request for at least one of (1) an initiation of a set of UE positioning related measurements for artificial intelligence (AI) or machine learning (ML) (AI/ML) training at the first network entity, or (2) a ground truth label for the AI/ML training at the first network entity; and
receive, based on the request, at least one of: (1) an indication to perform the set of UE positioning related measurements or (2) the ground truth label.

2. The apparatus of claim 1, wherein reception of the indication to perform the set of UE positioning related measurements is based on transmission of the request for the initiation of the set of UE positioning related measurements for the AI/ML training at the first network entity.

3. The apparatus of claim 2, wherein the second network entity is an access and mobility management function (AMF) or a gateway mobile location center (GMLC).

4. The apparatus of claim 1, wherein the indication to perform the set of UE positioning related measurements corresponds to a configuration for a set of sounding reference signals (SRS) to be transmitted from at least one user equipment (UE).

5. The apparatus of claim 1, wherein the request for the initiation of the set of UE positioning related measurements further includes at least one of:
a second indication to provide a feedback for at least one AI/ML model associated with the AI/ML training,
a duration for the at least one AI/ML model to be used for the AI/ML training,
a measurement type for the at least one AI/ML model to be used for the AI/ML training, or
a set of sounding reference signals (SRSs) characteristic associated with the at least one AI/ML model.

6. The apparatus of claim 1, wherein the request for the initiation of the set of UE positioning related measurements further includes at least one identifier (ID) of at least one user equipment (UE) that can be used for identifying the at least one UE over a New Generation (NG) interface, the at least one processor, individually or in any combination, is further configured to:
receive, from a location management function (LMF), one or more New Radio Positioning Protocol A (NRPPa) messages with a correlation ID, wherein the correlation ID is derived based on the at least one ID of the at least one UE.

7. The apparatus of claim 6, wherein the first network entity is a base station and the second network entity is an access and mobility management function (AMF).

8. The apparatus of claim 1, wherein reception of the ground truth label is based on transmission of the request for the ground truth label for the AI/ML training at the first network entity.

9. The apparatus of claim 8, wherein the ground truth label is received via at last one of a New Radio Positioning Protocol A (NRPPa) message or a Next Generation Access Point (NGAP) message, including at least one of a routing identifier (ID), a correlation ID, or at least one ID of at least one user equipment (UE).

10. The apparatus of claim 8, wherein the at least one processor, individually or in any combination, is further configured to:
perform the AI/ML training or AI/ML monitoring based on the ground truth label.

11. The apparatus of claim 1, wherein the ground truth label corresponds to at least one of a location of a user equipment (UE) derived by the second network entity or a true UE position obtained based on a set of sounding reference signals (SRSs) measurements.

12. The apparatus of claim 1, wherein the at least one processor, individually or in any combination, is further configured to:
transmit, to the second network entity, a measurement report associated with the set of UE positioning related measurements, wherein the measurement report indicates whether the set of UE positioning related measurements is based on an actual measurement or an AI/ML derived measurement; and
receive, from the second network entity, a feedback related to the measurement report.

13. The apparatus of claim 1, wherein the request further includes a second indication to provide a feedback for at least one AI/ML model associated with the AI/ML training, the at least one processor, individually or in any combination, is further configured to:
receive, from the second network entity, the feedback related to the at least one AI/ML model.

14. The apparatus of claim 1, further comprising:
receiving, from a location management function (LMF), a measurement initiation message that includes at least one of: (1) transmission reception point (TRP) information, (2) a set of sounding reference signal (SRS) configurations, (3) a set of TRP measurement quantities, (4) a duration for measurement, (5) a set of measurement types, or (6) a ground truth label.

15. A method of wireless communication at a first network entity, comprising:
transmitting, to a second network entity, a request for at least one of (1) an initiation of a set of UE positioning related measurements for artificial intelligence (AI) or machine learning (ML) (AI/ML) training at the first network entity, or (2) a ground truth label for the AI/ML training at the first network entity; and
receiving, based on the request, at least one of: (1) an indication to perform the set of UE positioning related measurements or (2) the ground truth label.

16. An apparatus for wireless communication at a second network entity, comprising:
at least one memory; and
at least one processor coupled to the at least one memory, the at least one processor, individually or in any combination, is configured to:
receive a request for at least one of (1) an initiation of a set of UE positioning related measurements for artificial intelligence (AI) or machine learning (ML) (AI/ML) training at a first network entity, or (2) a ground truth label for the AI/ML training at the first network entity; and
transmit, to the first network entity based on the request, at least one of: (1) an indication to perform the set of UE positioning related measurements or (2) the ground truth label.

17. The apparatus of claim 16, wherein the indication to perform the set of UE positioning related measurements corresponds to a configuration for a set of sounding reference signals (SRS) to be transmitted from at least one user equipment (UE).

18. The apparatus of claim 16, wherein the request for the initiation of the set of UE positioning related measurements further includes at least one of:
a second indication to provide a feedback for at least one AI/ML model associated with the AI/ML training,
a duration for the at least one AI/ML model to be used for the AI/ML training,
a measurement type for the at least one AI/ML model to be used for the AI/ML training, or
a set of sounding reference signals (SRSs) characteristic associated with the at least one AI/ML model.

19. The apparatus of claim 16, wherein the request for the initiation of the set of UE positioning related measurements further includes a correlation ID, the at least one processor, individually or in any combination, is further configured to:
transmit, to the first network entity, one or more New Radio Positioning Protocol A (NRPPa) messages with the correlation ID.

20. The apparatus of claim 16, wherein the at least one processor, individually or in any combination, is further configured to:
receive, from the first network entity, a measurement report associated with the set of UE positioning related measurements, wherein the measurement report indicates whether the set of UE positioning related measurements is based on an actual measurement or an AI/ML derived measurement; and
transmit, to the first network entity, a feedback related to the measurement report.
